(19) United States
(12) Patent Application Publication
(10) Pub. No.: US 2006/0051526 A1
(43) Pub. Date: Mar. 9, 2006

(54) Process for producing cellulose acylate film

(75) Inventors: Nobutaka Fukagawa, Kanagawa (JP); Masahiko Murayama, Kanagawa (JP); Yoshihiko Murayama, Kanagawa (JP); Honoka Murayama, Kanagawa (JP); Kurumi Murayama, Kanagawa (JP); Eiichiro Aminaka, Kanagawa (JP); Hiroshi Kawamoto, Kanagawa (JP); Satoshi Sakamaki, Kanagawa (JP); Hiroyuki Kawanishi, Kanagawa (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Kanagawa (JP)

(21) Appl. No.: 10/532,562

(22) PCT Filed: Oct. 23, 2003
(86) PCT No.: PCT/JP03/13538

§ 371 Date: Apr. 25, 2005

(30) Foreign Application Priority Data
Oct. 24, 2002 (JP) 2002-309797
Oct. 30, 2002 (JP) 2002-315506
Oct. 30, 2002 (JP) 2002-315605

(51) Int. Cl. C09K 19/00

(52) U.S. Cl. 428/1.31; 427/372.2; 427/377

(57) ABSTRACT

The present invention relates to a process for producing a cellulose acylate film, and an optical compensation sheet, a polarizing plate, and an image display device employing the cellulose acylate film. The process for producing a cellulose acylate film of the present invention is characterized by including a step of preparing a cellulose acylate solution containing 0.01 to 20 parts by weight of an aromatic compound having at least two aromatic rings relative to 100 parts by weight of a cellulose acylate, a step of casting, and a step of blowing a gas on the cast cellulose acylate solution at an effective wind speed of at least 10 m/min during a first half of drying prior to peel-off.

### TECHNICAL FIELD

The present invention relates to a process for producing a cellulose ester film, and an optical compensation sheet, a polarizing plate, and an image display device (a reflective type or semi-transmissive type liquid crystal display device) employing the cellulose ester film.

### BACKGROUND ART

Cellulose acylate films are used in various types of photographic materials and optical materials because of their toughness, flame retardancy, optical isotropy, etc. The cellulose acylate films are generally produced by a solvent cast method. In the solvent cast method, a film is formed by casting on a support a solution (a dope) of a cellulose acylate dissolved in a solvent, and drying so as to evaporate the solvent. The solvent cast method can give a film having excellent flatness. The object of the solvent cast method is to reduce the time required after casting the dope on the support and before peeling off the film thus formed on the support, thereby improving the productivity of the film formation process. Because of this, casting a high concentration dope on a cooling drum to thereby reduce the time after casting and before peeling off has been proposed (e.g., JP-B-5-17844 (JP-B denotes a Japanese examined patent application publication)).

The solvent used in the solvent cast method is required to satisfy various requirements other than simply dissolving the cellulose acylate. That is, in order to produce economically and efficiently a film having excellent flatness and uniform thickness, it is necessary to prepare a solution having appropriate viscosity and polymer concentration and excellent storage stability. The dope is also required to gel easily and be easily peeled off from the support. In order to prepare such a dope, selection of the type of solvent is extremely important. The solvent also has to evaporate easily, thereby reducing the amount thereof remaining in the film. Because of these reasons, several types of solvents are often mixed, and the cellulose acylate is dissolved in the mixed solvent.

Use of an optical compensation sheet in a liquid crystal display device in order to increase the viewing angle, improve the image color, and enhance the contrast is a widely known technique. In particular, a film formed by adding a highly planar low molecular weight compound to a cellulose ester allows its retardation to be adjusted over a wide range and is especially useful, and specific examples thereof are disclosed in, for example, JP-A-2000-111914 and JP-A-2000-166144 (JP-A denotes a Japanese unexamined patent application publication).

In the case where a cellulose acylate film is used as an optical compensation sheet, in order to impart optical functions thereto, a functional additive may be added to the cellulose acylate film. Although it is possible to add the functional additive when the wt % of the additive is low or when its burden during drying is small, in the case where it is desired to add a large amount thereof or the drying burden is high, a phenomenon in which the functional additive exudes onto the film surface (bleed-out, weeping) has occurred. Weeping causes the surface to be stained, thus preventing a film having an excellent surface condition from being obtained. Since films in which weeping has occurred have a very uneven surface, there is the problem that they cause an uneven display in a liquid crystal display device. There is also the problem that the production process is contaminated and continuous and stable production cannot be carried out.

However, an effective method for preventing weeping has not been found, and there has been a desire for a technique that can suppress weeping and give a film having a good surface condition.

### DISCLOSURE OF INVENTION

The object of the present invention is to provide a process for producing a cellulose acylate film and an optical compensation film comprising a cellulose acylate film, wherein in particular an optical compensation film additive (a plasticizer, a retardation control agent, a UV absorbing agent, etc.) can be prevented from being deposited on the film surface (weeping) during the production process, and a film having a high retardation value and a surface condition in which optical uniformity within the film is excellent can be obtained with high productivity and efficiency.

Another object of the present invention is to provide an optical compensation sheet, a polarizing plate, and a liquid crystal display device employing a cellulose ester film having the above-mentioned excellent properties.

As a result of an intensive investigation, the present inventors have found that the above objects can be attained by drying a film rapidly, and promptly fixing a retardation increasing agent within the cellulose ester.

As a result of an intensive investigation, the present inventors have found that the so-called weeping is observed when, with regard to a cellulose acylate solution containing a cellulose acylate and at least two types of organic solvents, the proportion of an organic solvent in which the solubility of the additive is poor (hereinafter called a ‘poor solvent’) increases in a dope or gel during drying, thus reducing the solubility of the additive, and the present invention has been accomplished by selecting a solvent that can prevent this weeping.

As a result of an intensive investigation in order to solve the above-mentioned problems, the present inventors have found that weeping depends on the degree of stabilization energy that the retardation control agent receives from a cellulose acylate, a plasticizer, or a mixed system of a cellulose acylate and a plasticizer, etc., and the present invention has thus been accomplished. Furthermore, the present inventors have found that weeping is observed when, while drying a cellulose acylate solution containing a cellulose acylate and at least two types of organic solvents, the proportion of an organic solvent in which the solubility of the additive is poor (hereinafter called a ‘poor solvent’) increases in a dope or gel during drying, thus decreasing the stabilization energy receiving from the solution system, and the present invention has thus been accomplished.

That is, the present invention is a cellulose ester film, an optical compensation sheet, a polarizing plate, and a liquid crystal display device, having the following constitutions.

Preferred embodiments are also listed below.
1) A process for producing a cellulose acylate film, the process comprising a step of preparing a cellulose acylate solution containing 0.01 to 20 parts by weight of an aromatic compound having at least two aromatic rings relative to 100 parts by weight of a cellulose acylate, a step of casting the cellulose acylate solution on a band or a drum, and a step of blowing a gas on the cast cellulose acylate solution at an effective wind speed of at least 10 m/min during a first half of drying prior to peel-off,
2) the process for producing a cellulose acylate film of 1), wherein the degree of acylation (for example acetylation) of the cellulose acylate is in the range of 59.0% to 61.5%,
3) the process for producing a cellulose acylate film according to 1) or 2), wherein the aromatic compound is a compound represented by Formulae (I) to (IV) below, 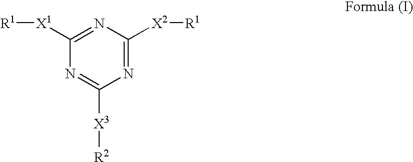
in Formula (I);
R¹ denotes an aromatic ring or a hetero ring having a substituent at the ortho position and/or the meta position, and R² denotes an aromatic ring or a hetero ring which may be substituted; it is preferable that, when R¹ and R² denote aromatic rings, both are not identical;
X¹ denotes a single bond or —NR³—, X² denotes a single bond or —NR⁴—, and X³ denotes a single bond or —NR⁵—; R³, R⁴, and R⁵ independently denote a hydrogen atom, or a substituted or unsubstituted alkyl group, alkenyl group, aryl group, or heterocyclic group; 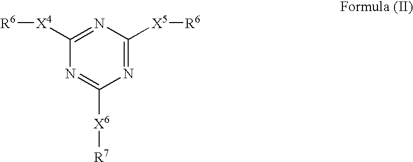
in Formula (II);
R⁶ denotes an aromatic ring or a hetero ring having a substituent at the para position, and R⁷ denotes an aromatic ring or a hetero ring having a substituent, provided that when R⁶ and R⁷ denote aromatic rings, both are not identical;
X⁴ denotes a single bond or —NR¹³—, X⁵ denotes a single bond or —NR¹⁴—, and X⁶ denotes a single bond or —NR¹⁵—; R¹³, R¹⁴, and R¹⁵ independently denote a hydrogen atom, or a substituted or unsubstituted alkyl group, alkenyl group, aryl group, or heterocyclic group; 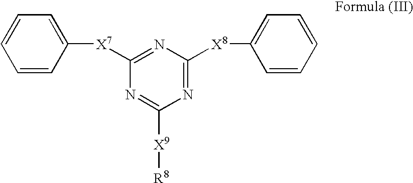
in Formula (III);
R⁸ denotes an aromatic ring or a hetero ring having a substituent at the ortho position and/or the meta position;
X⁷ denotes a single bond or —NR²³—, X⁸ denotes a single bond or —NR²⁴—, and X⁹ denotes a single bond or —NR²⁵—; R²³, R²⁴, and R²⁵ independently denote a hydrogen atom, or a substituted or unsubstituted alkyl group, alkenyl group, aryl group, or heterocyclic group; 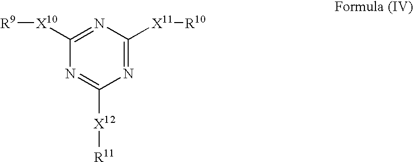
in Formula (IV);
R⁹, R¹⁰, and R¹¹ denote different aromatic rings or hetero rings, which may be substituted;
X¹⁰ denotes a single bond or —NR³³—, X¹¹ denotes a single bond or —NR³⁴ and X¹² denotes a single bond or —NR³⁵—; R³³, R³⁴, and R³⁵ independently denote a hydrogen atom, or a substituted or unsubstituted alkyl group, alkenyl group, aryl group, or heterocyclic group,
4) the process for producing a cellulose acylate film according to any one of 1) to 3), wherein the retardation value Re of the cellulose acylate film calculated from the equation below is in the range of 20 to 100 nm,
   Retardation value Re=(nx−ny)×d
   (here, nx denotes the refractive index in the direction of the phase retardation axis within the film (direction in which the refractive index is maximum), ny denotes the refractive index in the direction of the phase advance axis within the film (direction in which the refractive index is minimum), and d denotes the thickness (nm) of the film),
5) a process for producing a cellulose acylate film, the process comprising
a step of preparing a cellulose acylate solution containing a cellulose acylate, a functional additive, a first organic solvent, and a second organic solvent, the solubilities of the functional additive in the first organic solvent and the second organic solvent being different,
a step of casting the cellulose acylate solution on a band or a drum, and
a step of drying the cast cellulose acylate solution so as to remove the organic solvents therefrom, wherein
the solvent composition of mixed organic solvent in the cast cellulose acylate solution changes during the drying step, and
when S1(25) (solids weight concentration of the functional additive) is the solubility of the functional additive at 25° C. in the mixed organic solvent having a solvent composition where the proportion by weight of the first organic solvent, in which the solubility of the functional additive is the lowest, is the highest in the mixed organic solvent, and S0(25) (solids weight concentration of the functional additive) is the solubility of the functional additive at 25° C. in the mixed organic solvent of the solvent composition in the step of preparing the cellulose acylate solution, then for the cellulose acylate solution that is cast,
   0≦S0(25)−S1(25)<12.5 or
   S1(25)/S0(25)≧0.5,
6) a process for producing a cellulose acylate film, the process comprising
a step of preparing a cellulose acylate solution containing a cellulose acylate, a functional additive, a first organic solvent, and a second organic solvent, the solubilities of the functional additive in the first organic solvent and the second organic solvent being different,
a step of casting the cellulose acylate solution on a band or a drum, and
a step of drying the cast cellulose acylate solution so as to remove the organic solvents therefrom, wherein
the solvent composition of mixed organic solvent in the cast cellulose acylate solution changes during the drying step, and
when S1(20) (solids weight concentration of the functional additive) is the solubility of the functional additive at 20° C. in the mixed organic solvent having a solvent composition where the proportion by weight of the first organic solvent, in which the solubility of the functional additive is the lowest, is the highest in the mixed organic solvent, and S0(20) (solids weight concentration of the functional additive) is the solubility of the functional additive at 20° C. in the mixed organic solvent of the solvent composition in the step of preparing the cellulose acylate solution, then for the cellulose acylate solution that is cast,
   0≦S0(20)−S1(20)<12.5 or
   S1(20)/S0(20)≧0.5,
7) a process for producing a cellulose acylate film, the process comprising
a step of preparing a cellulose acylate solution containing a cellulose acylate, a functional additive, a first organic solvent, and a second organic solvent, the solubilities of the functional additive in the first organic solvent and the second organic solvent being different,
a step of casting the cellulose acylate solution on a band or a drum, and
a step of drying the cast cellulose acylate solution so as to remove the organic solvents therefrom, wherein
the solvent composition of the mixed organic solvent in the cast cellulose acylate solution changes during the drying step, and
when S1(35) (solids weight concentration of the functional additive) is the solubility of the functional additive at 35° C. in the mixed organic solvent having a solvent composition where the proportion by weight of the first organic solvent, in which the solubility of the functional additive is the lowest, is the highest in the mixed organic solvent, and S0(35) (solids weight concentration of the functional additive) is the solubility of the functional additive at 35° C. in the mixed organic solvent of the solvent composition in the step of preparing the cellulose acylate solution, then for the cellulose acylate solution that is cast,
   0≦S0(35)<12.5 or
   S1(35)/S0(35)≧0.5,
8) a process for producing a cellulose acylate film, the process comprising
a step of preparing a cellulose acylate solution containing a cellulose acylate (a), an additive (b) selected from the group consisting of a plasticizer, a retardation control agent, a degradation inhibitor, and a UV absorbing agent, and an organic solvent or a mixed organic solvent (c),
a step of casting the cellulose acylate solution on a band or a drum, and
a step of drying the cast cellulose acylate solution so as to remove the organic solvent therefrom, wherein
for the cellulose acylate solution that is cast the heat of solution ΔH0 of the additive (b) in the organic solvent or mixed organic solvent (c) is larger than the heat of solution ΔHs thereof in a solution in which only the cellulose acylate (a) is dissolved, and ΔH0−ΔHs is 0.3 kcal/mol or more,
9) a process for producing a cellulose acylate film, the process comprising
a step of preparing a cellulose acylate solution containing a cellulose acylate (a), an additive (b′) selected from the group consisting of a retardation control agent, a degradation inhibitor, and a UV absorbing agent, a plasticizer (b1), and an organic solvent or a mixed organic solvent (c),
a step of casting the cellulose acylate solution on a band or a drum, and
a step of drying the cast cellulose acylate solution so as to remove the organic solvent therefrom, wherein
for the cellulose acylate solution that is cast, the heat of solution ΔH0 of the additive (b′) in the organic solvent or mixed organic solvent (c) is larger than the heat of solution ΔHs thereof in a solution in which the plasticizer (b1) alone is dissolved, and ΔH0−ΔHs is 0.3 kcal/mol or more,
10) a process for producing a cellulose acylate film, the process comprising
a step of preparing a cellulose acylate solution containing a cellulose acylate (a), an additive (b′) selected from the group consisting of a retardation control agent, a degradation inhibitor, and a UV absorbing agent, a plasticizer (b1), and an organic solvent or a mixed organic solvent (c),
a step of casting the cellulose acylate solution on a band or a drum, and
a step of drying the cast cellulose acylate solution so as to remove the organic solvent therefrom, wherein
for the cellulose acylate solution that is cast, the heat of solution ΔH0 of the additive (b′) in the organic solvent or mixed organic solvent (c) is larger than the heat of solution ΔHs thereof in a solution in which the cellulose acylate (a) and the plasticizer (b1) are dissolved, and ΔH0−ΔHs is 0.3 kcal/mol or more,
11) the process for producing a cellulose acylate film according to any one of 8) to 10), wherein the difference ΔH0−ΔHs of the heats of solution is 0.6 kcal/mol or more,
12) a process for producing a cellulose acylate film, wherein the cellulose acylate solution according to any one of 1) to 11) is cast as an outermost layer,
13) a cellulose acylate film produced by the process according to any one of 1) to 12),
14) an optical compensation film employing a cellulose acylate film produced by the production process according to any one of 1) to 12),
15) an optical compensation sheet provided with an optically anisotropic layer formed from a liquid crystal molecule on the cellulose acylate film according to 13),
16) an optical compensation film employing a cellulose acylate film produced by the production process according to any one of 5) to 12) wherein the additive is an aromatic compound having at least two aromatic rings, and the aromatic compound having at least two aromatic rings is contained at 0.01 to 20 parts by weight relative to 100 parts by weight of the cellulose acylate,
17) a polarizing plate comprising a transparent protective film, a polarizing film, a transparent support, and an optically anisotropic layer formed from a liquid crystal molecule laminated in that order, wherein the transparent support is the cellulose acylate film according to 13). The polarizing plate includes such a layer arrangement as the transparent support works as the optical anisotropic layer.
18) an image display device employing at least one of the optical compensation film according to 15) or 16) and the polarizing plate according to 17),
19) a liquid crystal display device comprising a liquid crystal cell, and two polarizing plates disposed on either side thereof, at least one of the polarizing plates being the polarizing plate of 17),
20) a polarizing plate comprising the optical compensation film according to 14) or 16) laminated to a polarizing film or a polarizing plate,
21) the liquid crystal display device according to 19), wherein the liquid crystal cell is a TN mode liquid crystal cell,
22) the liquid crystal display device according to 19), wherein the liquid crystal cell is a bend alignment mode liquid crystal cell, and
23) the liquid crystal display device according to 19), wherein the liquid crystal cell is a vertical alignment mode liquid crystal cell.

### BRIEF DESCRIPTION OF DRAWINGS

FIG. 1 shows a constitutional example in which the polarizing plate of the present invention and the functional optical film are combined.

FIG. 2 is a diagram showing the solubility of retardation control agents (Example compounds I-(51) and I-(2)) in dichloromethane/methanol mixed solvent at 25° C.

FIG. 3 is a diagram showing the solubility of retardation control agents (Example compounds I-(51) and I-(2)) in dichloromethane/methanol mixed solvent at 20° C.

FIG. 4 is a diagram showing the solubility of retardation control agents (Example compounds I-(51) and I-(2)) in dichloromethane/methanol mixed solvent at 35° C.

### BEST MODE FOR CARRYING OUT THE INVENTION

(Retardation Increasing Agent)

A cellulose acylate for a support film employs an aromatic compound having at least two aromatic rings as a retardation increasing agent (hereinafter, also called a ‘retardation control agent’) in order to adjust the retardation of the film.

The above-mentioned aromatic compound is used in the range of 0.01 to 20 parts by weight relative to 100 parts by weight of cellulose acetate, preferably in the range of 0.05 to 15 parts by weight, and more preferably in the range of 0.1 to 10 parts by weight. Two or more types of aromatic compounds may be used in combination.

The aromatic ring of the aromatic compound includes an aromatic hetero ring in addition to an aromatic hydrocarbon ring.

The molecular weight of the retardation control agent is preferably 300 to 800 (ref. International Patent Application No. WO00/65384).

Specific examples of the aromatic compound of the present invention are preferably compounds described in JP-A-2001-166144.

Thereamong, aromatic compounds having a 1,3,5-triazine ring represented by Formulae (I) to (IV) below are particularly preferred since they have an excellent effect in increasing the retardation, use of a comparatively small amount thereof can increase the retardation of a cellulose ester film, and a film having highly uniform retardation within the film can be obtained.

Compounds represented by Formulae (I) to (IV) are explained in detail below. 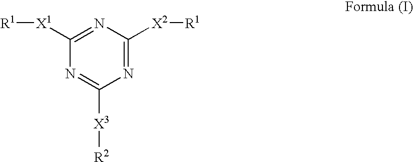
R¹ denotes an aromatic ring or a hetero ring having a substituent at the ortho position and/or the meta position, and R² denotes an aromatic ring or a hetero ring which may be substituted. When R¹ and R² denote aromatic rings, it is preferable that both are not identical.

X¹ denotes a single bond or —NR³—, X² denotes a single bond or —NR⁴—, and X³ denotes a single bond or —NR⁵—. R³, R⁴, and R⁵ independently denote a hydrogen atom, or a substituted or unsubstituted alkyl group, alkenyl group, aryl group, or heterocyclic group.

More specifically, R¹ denotes an aromatic ring or a hetero ring having a substituent at the ortho position and/or the meta position, and R² denotes an aromatic ring or a hetero ring having a substituent. The aromatic ring denoted by each of R¹ and R² is preferably phenyl or naphthyl, and particularly preferably phenyl. The aromatic ring denoted by R¹ has at least a substituent at the ortho position and/or the meta position and may have a substituent at other positions. It is preferable that the aromatic ring denoted by R² has at least one substituent at any substitution position. Examples of the substituent include a halogen atom, hydroxyl, cyano, nitro, carboxyl, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, carbamoyl, an alkyl-substituted carbamoyl group, an alkenyl-substituted carbamoyl group, an aryl-substituted carbamoyl group, an amide group, an alkylthio group, an alkenylthio group, an arylthio group, and an acyl group.

Thereamong, a lower alkyl group having 1 to 5 carbon atoms (e.g., methyl, ethyl, isopropyl, butyl, t-butyl), a lower alkoxy group having 1 to 5 carbon atoms, an alkoxycarbonyl group having 2 to 6 carbon atoms and having a lower alkyl group, a lower alkylthio group having 1 to 5 carbon atoms, a halogen atom (e.g., Cl, Br, F), etc. are preferred.

These substituents may be further substituted with another substituent if possible, and a trifluoromethyl group can be cited as an example.

When R¹ denotes an aromatic ring having a substituent at the ortho position and/or the meta position and R² denotes an aromatic ring having a substituent, both are not identical. ‘Not identical’ referred to there means that they, including their substituents, are not identical and, for example, a case in which they have an identical aromatic ring but different substituents, and a case in which, furthermore, their substituents are identical but the substitution positions are different are included in ‘not identical’.

The heterocyclic group denoted by each of R¹ and R² preferably has aromaticity. A hetero ring having aromaticity is generally an unsaturated hetero ring, and preferably a hetero ring having the maximum number of double bonds. The hetero ring is preferably a 5-membered ring, a 6-membered ring, or a 7-membered ring, more preferably a 5-membered ring or a 6-membered ring, and most preferably a 6-membered ring. A hetero atom of the hetero ring is preferably a nitrogen atom, a sulfur atom, or an oxygen atom, and particularly preferably a nitrogen atom. The hetero ring having aromaticity is particularly preferably a pyridine ring (as a heterocyclic group, 2-pyridyl or 4-pyridyl). The heterocyclic group may have a substituent. Examples of the substituent on the heterocyclic group are the same as the above-mentioned examples of the substituent on the aryl portion. The heterocyclic group when X¹, X², and X³ are each a single bond is preferably a heterocyclic group having free valence on a nitrogen atom. The heterocyclic group having free valence on the nitrogen atom is preferably a 5-membered ring, a 6-membered ring, or a 7-membered ring, more preferably a 5-membered ring or a 6-membered ring, and most preferably a 5-membered ring. The heterocyclic group may have a plurality of nitrogen atoms. Furthermore, the heterocyclic group may have a hetero atom (e.g., O, S) other than nitrogen atom. Examples of the heterocyclic group having free valence on the nitrogen atom are illustrated below.

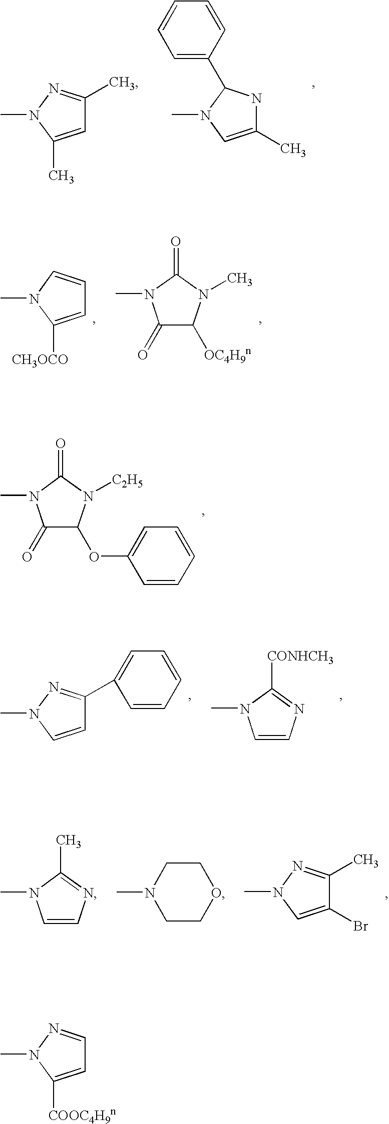

In Formula (I), X¹ denotes a single bond or —NR³—, X² denotes a single bond or —NR⁴—, and X³ denotes a single bond or NR⁵—. R³, R⁴, and R⁵ independently denote a hydrogen atom, or a substituted or unsubstituted alkyl group, alkenyl group, aryl group, or heterocyclic group.

The alkyl group denoted by each of R³, R⁴, and R⁵ may be a cyclic alkyl group or an open-chain alkyl group, and preferably an open-chain alkyl group, a straight open-chain alkyl group being preferred to a branched open-chain alkyl group. The number of carbon atoms in the alkyl group is preferably 1 to 30, more preferably 1 to 20, yet more preferably 1 to 10, yet more preferably 1 to 8, and most preferably 1 to 6. The alkyl group may have a substituent. Examples of the substituent include a halogen atom, an alkoxy group (e.g., methoxy, ethoxy), and an acyloxy group (e.g., acryloyloxy, methacryloyloxy).

The alkenyl group denoted by each of R³, R⁴, and R⁵ may be a cyclic alkenyl group or an open-chain alkenyl group, and preferably an open-chain alkenyl group, a straight open-chain alkenyl group being preferred to a branched open-chain alkenyl group. The number of carbon atoms in the alkenyl group is preferably 2 to 30, more preferably 2 to 20, yet more preferably 2 to 10, yet more preferably 2 to 8, and most preferably 2 to 6. The alkenyl group may have a substituent. Examples of the substituent are the same as those on the alkyl group above.

The aromatic ring group (aryl group) and the heterocyclic group denoted by each of R³, R⁴, and R⁵ are the same as the aromatic ring and hetero ring denoted by each of R¹ and R², and their preferred ranges are also the same. The aromatic ring group and the heterocyclic group may further have a substituent, and examples of the substituent are the same as those on the aromatic ring and the hetero ring of R¹ and R².

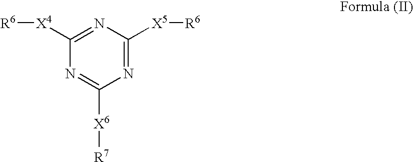

In Formula (II), R⁶ denotes an aromatic ring or a hetero ring having a substituent at the para-position, and R⁷ denotes an aromatic ring or a hetero ring having a substituent, provided that when R⁶ and R⁷ denote aromatic rings, both are not identical.

X⁴ denotes a single bond or —NR¹³—, X⁵ denotes a single bond or —NR¹⁴ and X⁶ denotes a single bond or —NR¹⁵—. R¹³, R¹⁴, and R¹⁵ independently denote a hydrogen atom, or a substituted or unsubstituted alkyl group, alkenyl group, aryl group, or heterocyclic group.

The aromatic ring and the hetero ring denoted by each of R⁶ and R⁷ are the same as the aromatic ring and the hetero ring denoted by each of R¹ and R² in Formula (I) above, and their preferred ranges are also the same. Examples of the substituent thereon are also the same as those cited as examples for the substituent on the aromatic ring and the hetero ring denoted by each of R¹ and R². The aromatic ring denoted by R⁶ at least has a substituent at the para-position and may have a substituent at another position, and R⁷ has at least one substituent at any position, provided that when R⁶ denotes an aromatic ring having a substituent at the para position and R⁷ denotes aromatic ring having a substituent, both are not identical. ‘Not identical’ referred to here means that they, including their substituents, are not identical and, for example, a case in which they have an identical aromatic ring but different substituents, and a case in which, furthermore, their substituents are identical but the substitution positions are different are included in ‘not identical’.

X⁴ denotes a single bond or —NR¹³—, X⁵ denotes a single bond or —NR¹⁴—, and X⁶ denotes a single bond or —NR¹⁵—. R¹³, R¹⁴, and R¹⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R¹³, R¹⁴, and R¹⁵ is the same as the group denoted by each of R³, R⁴, and R⁵ in Formula (I) above, and the preferred range is also the same.

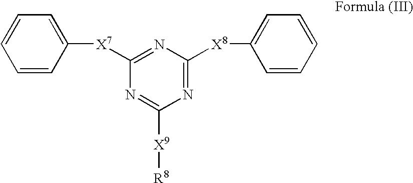

In Formula (III), R⁸ denotes an aromatic ring or a hetero ring having a substituent at the ortho position and/or the meta position. X⁷ denotes a single bond or —NR²³—, X⁸ denotes a single bond or —NR²⁴—, and X⁹ denotes a single bond or —NR²⁵—. R²³, R²⁴, and R²⁵ independently denote a hydrogen atom, or a substituted or unsubstituted alkyl group, alkenyl group, aryl group, or heterocyclic group.

The aromatic ring and the hetero ring denoted by R⁸ are the same as the aromatic ring and the hetero ring denoted by each of R¹ and R² in Formula (I) above, and their preferred ranges are also the same. Examples of the substituent thereon are also the same as those cited as examples for the substituent on the aromatic ring and the hetero ring denoted by each of R¹ and R². The aromatic ring denoted by R⁸ has at least a substituent at the ortho position and/or the meta position, and may have a substituent at another position including the para position.

X⁷ denotes a single bond or —NR²³—, X⁸ denotes a single bond or —NR²⁴—, and X⁹ denotes a single bond or —NR²⁵—. R²³, R²⁴, and R²⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R²³, R²⁴, and R²⁵ is the same as the group denoted by each of R³, R⁴, and R⁵ in Formula (I) above, and the preferred range is also the same.

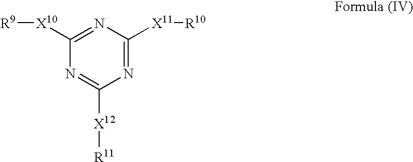

In Formula (IV), R⁹, R¹⁰, and R¹¹ denote different aromatic rings or hetero rings, which may be substituted. X¹⁰ denotes a single bond or —NR³³—, X¹¹ denotes a single bond or —NR³⁴—, and X¹² denotes a single bond or —NR³⁵—, R³³, R³⁴, and R³⁵ independently denote a hydrogen atom or a substituted or unsubstituted alkyl group, alkenyl group, aryl group, or heterocyclic group.

The aromatic ring or hetero ring denoted by each of R⁹, R¹⁰, and R¹¹ is the same as the aromatic ring and hetero ring denoted by each of R¹ and R² in Formula (I) above, and the preferred range is also the same. Examples of the substituent thereon are also the same as those cited as examples for the substituent on the aromatic ring and the hetero ring denoted by each of R¹ and R². ‘Different aromatic rings or hetero rings’ means that the aromatic rings and the hetero rings, including their substituents, are not identical and, for example, a case in which they have an identical aromatic ring or hetero ring but different substituents, and a case in which, furthermore, their substituents are identical but the substitution positions are different are included in ‘different aromatic rings or hetero rings’.

X¹⁰ denotes a single bond or —NR³³—, X¹¹ denotes a single bond or —NR³⁴ and X¹² denotes a single bond or —NR³⁵—. R³³, R³⁴, and R³⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R³³, R³⁴, and R³⁵ is the same as the group denoted by each of R³, R⁴, and R⁵ in Formula (I) above, and the preferred range is also the same.

The molecular weight of the aromatic compound as a retardation increasing agent of the present invention is preferably 300 to 2,000. The boiling point of the aromatic compound of the present invention is preferably 260° C. or higher. The boiling point can be measured using a commercial measurement instrument (for example, a TG/DTA100, manufactured by Seiko Electronic Industry Co., Ltd.)

Specific examples of the compound having a 1,3,5-triazine ring as a retardation increasing agent are illustrated below.

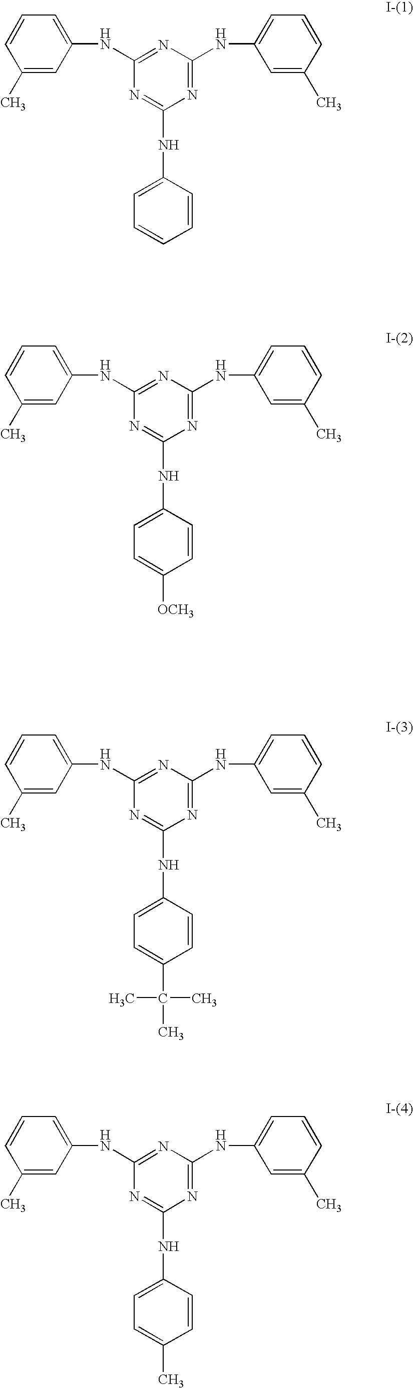

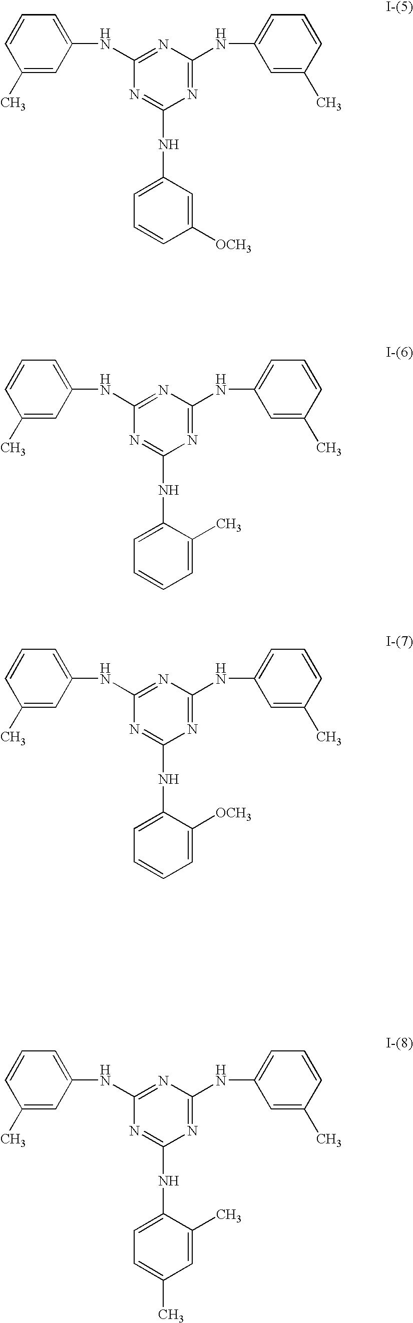

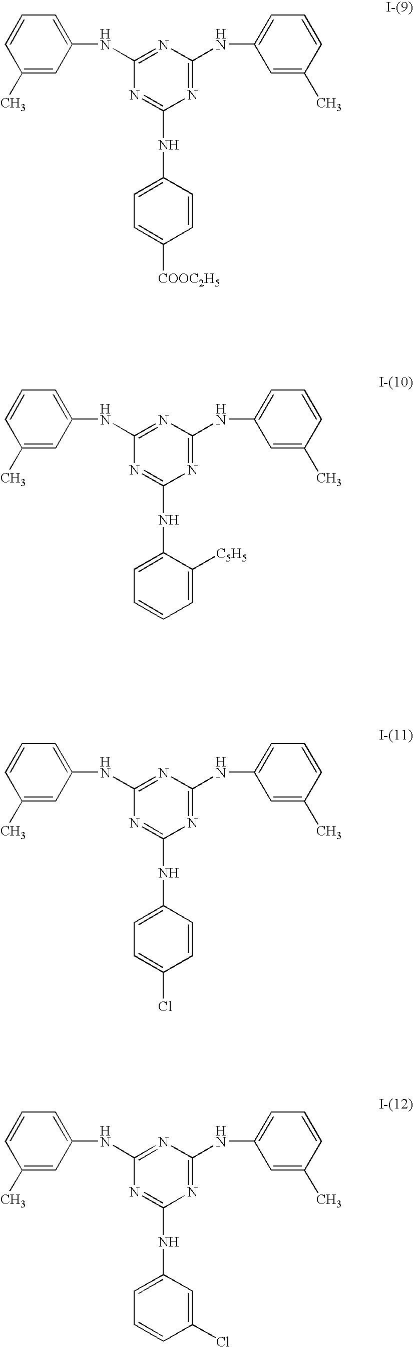

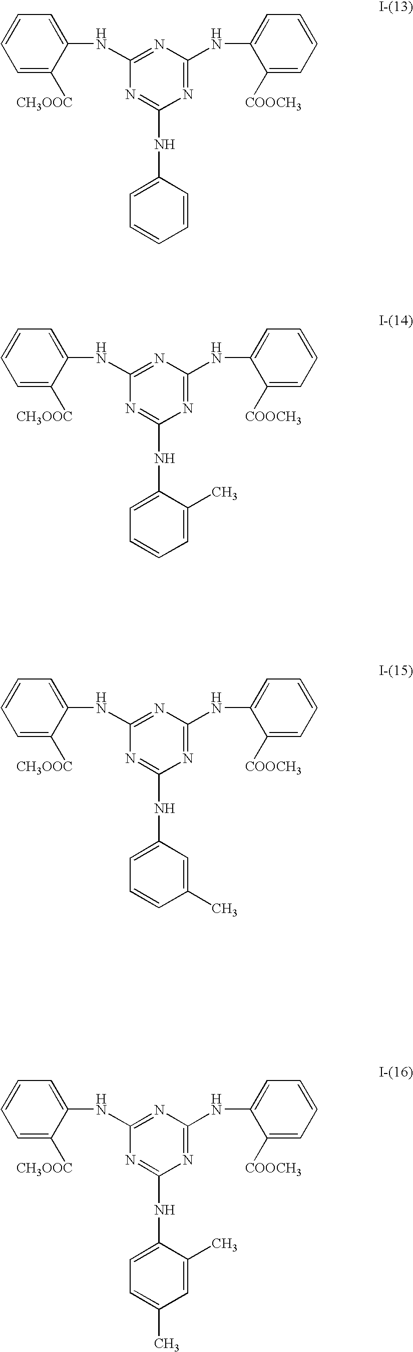

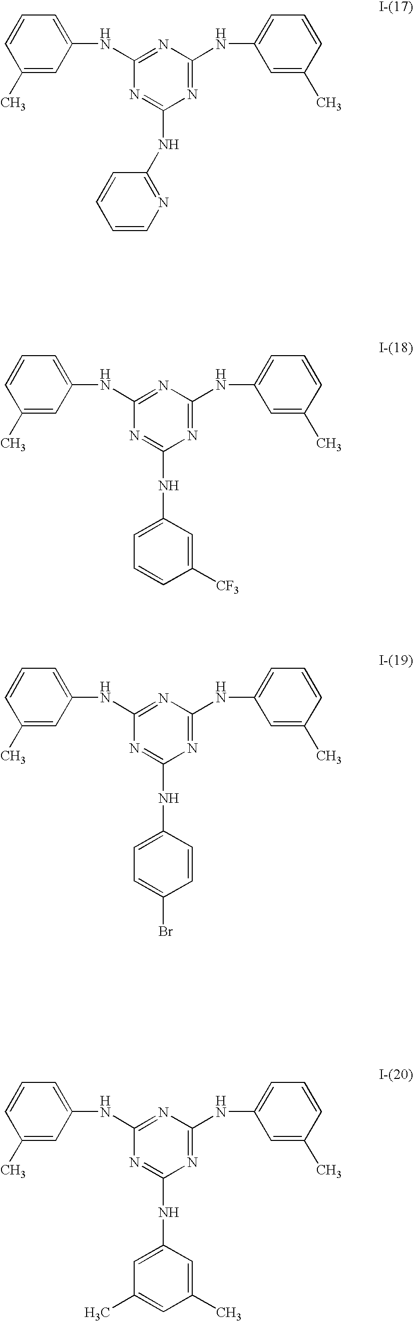

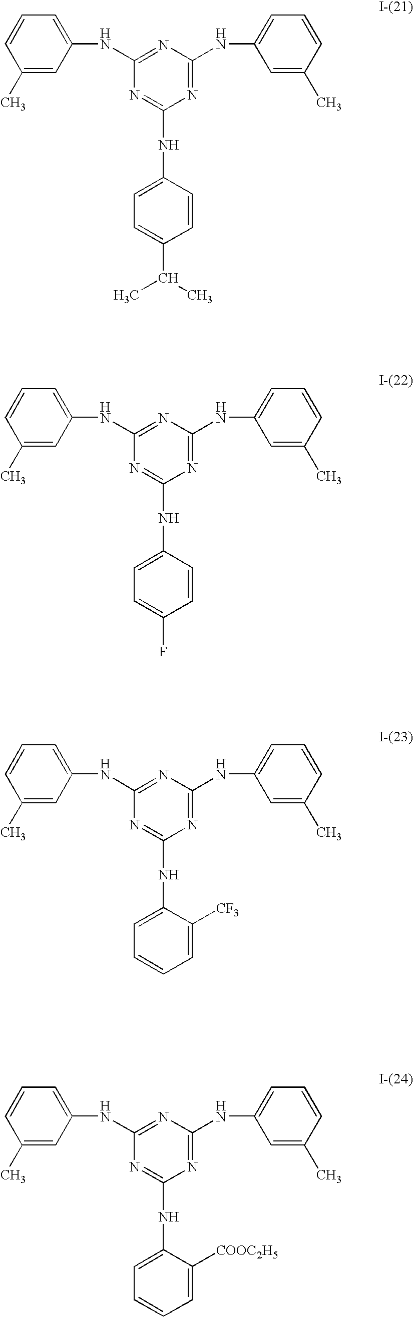

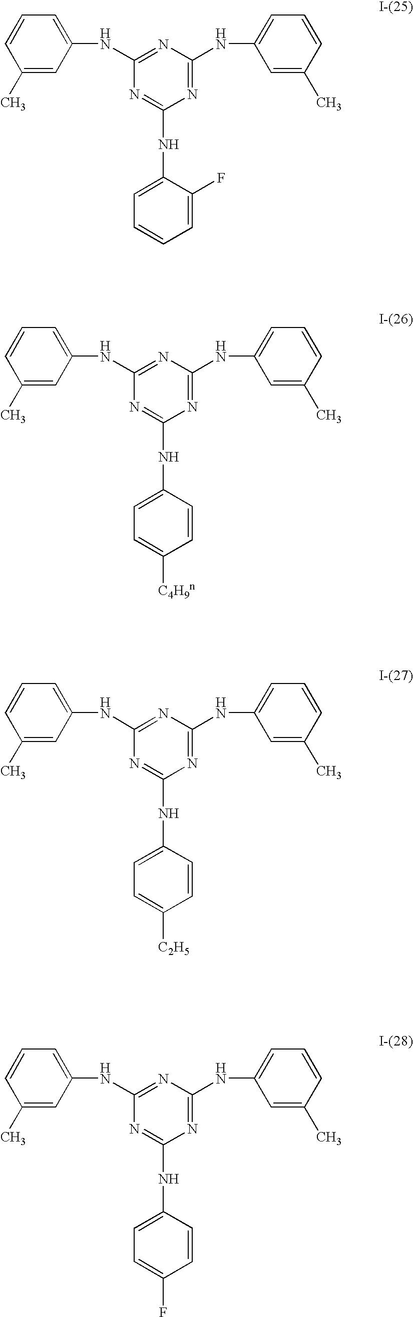

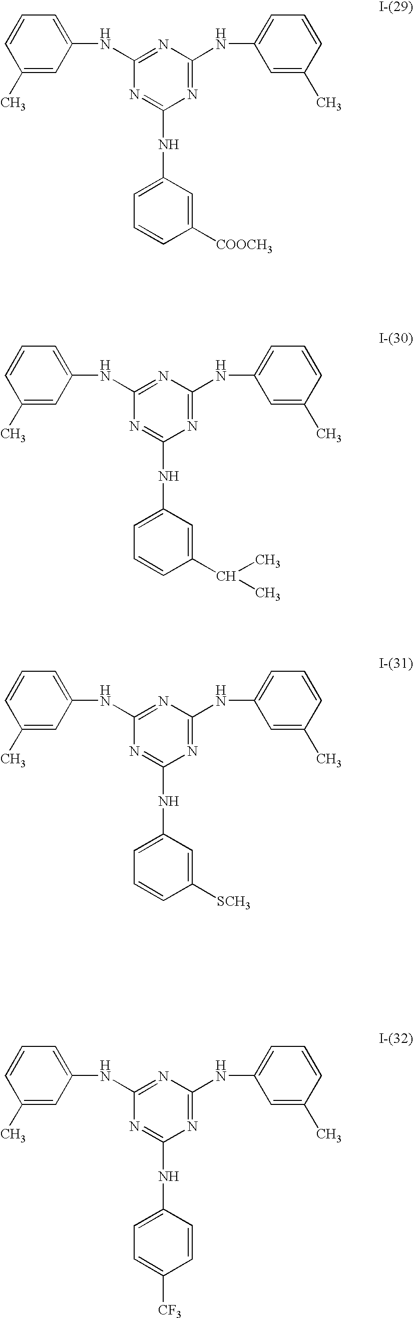

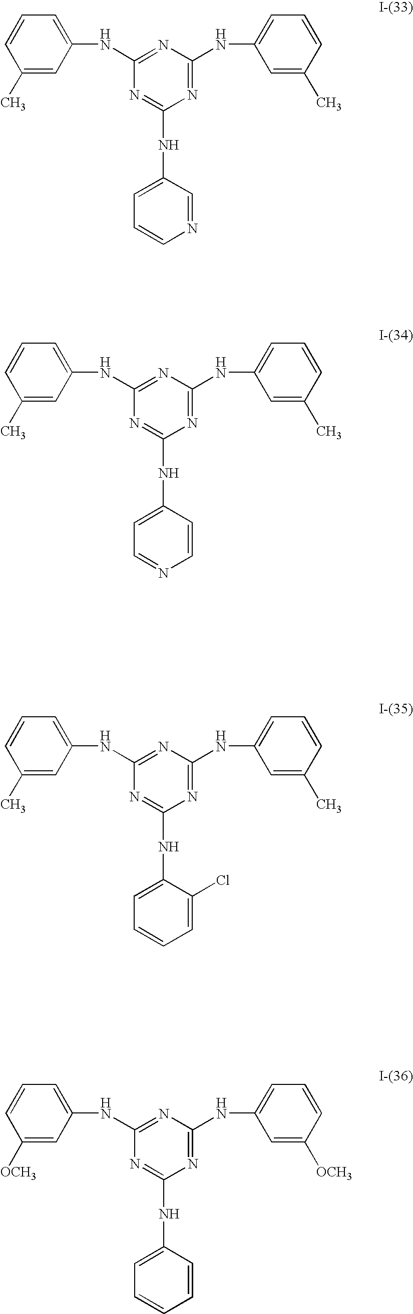

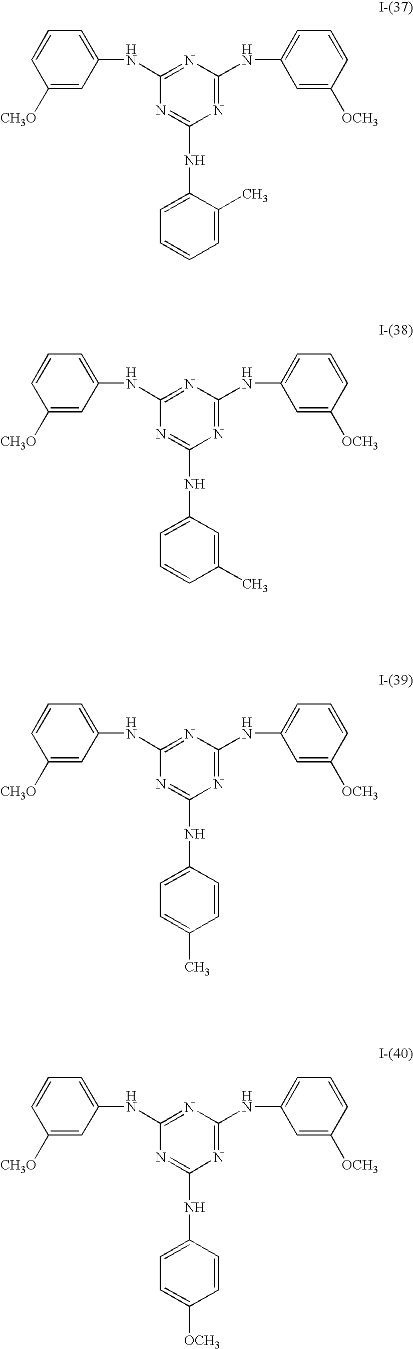

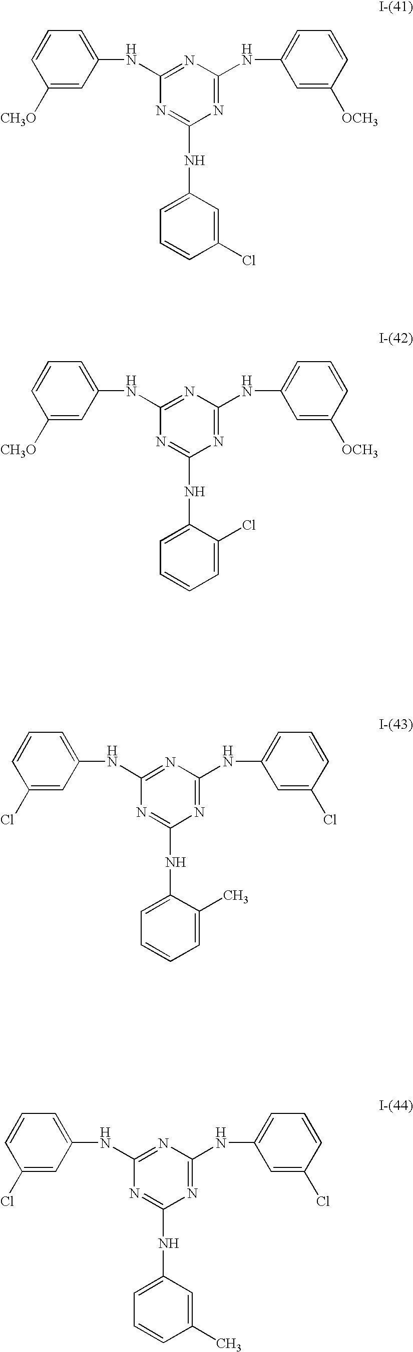

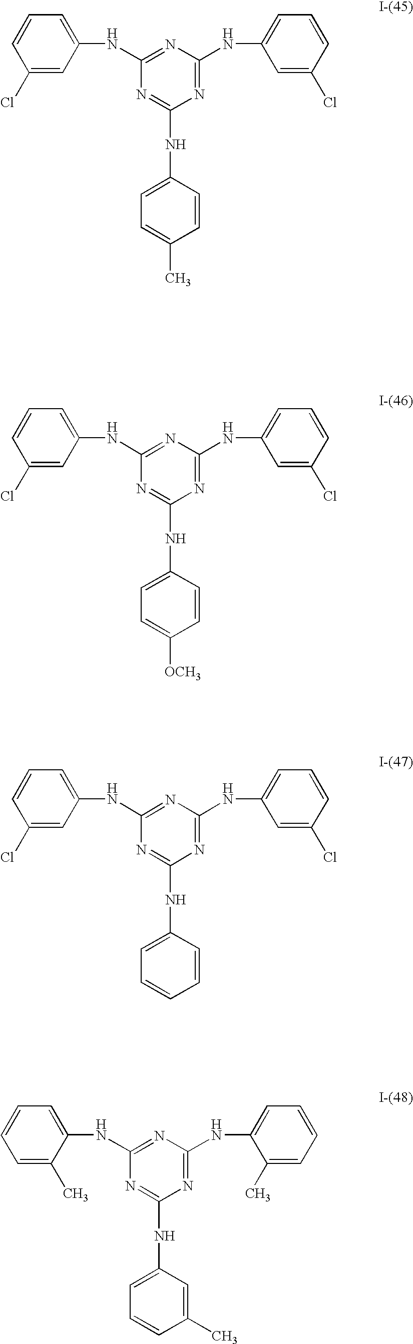

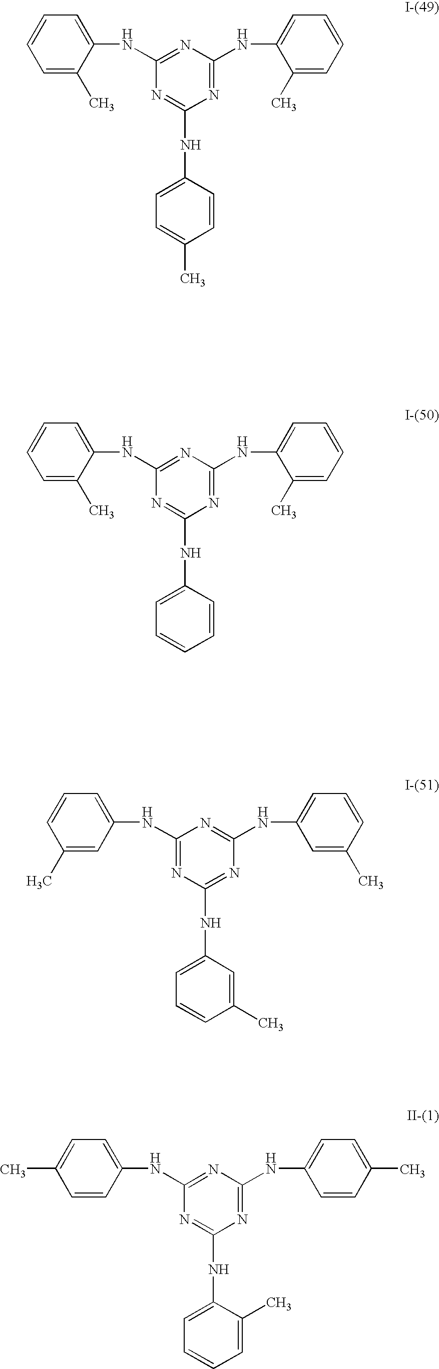

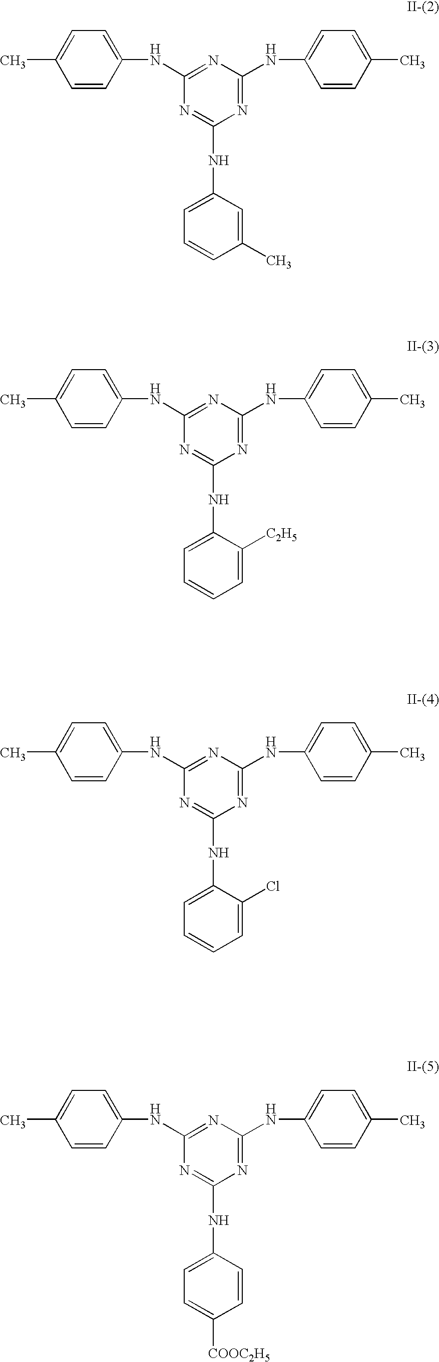

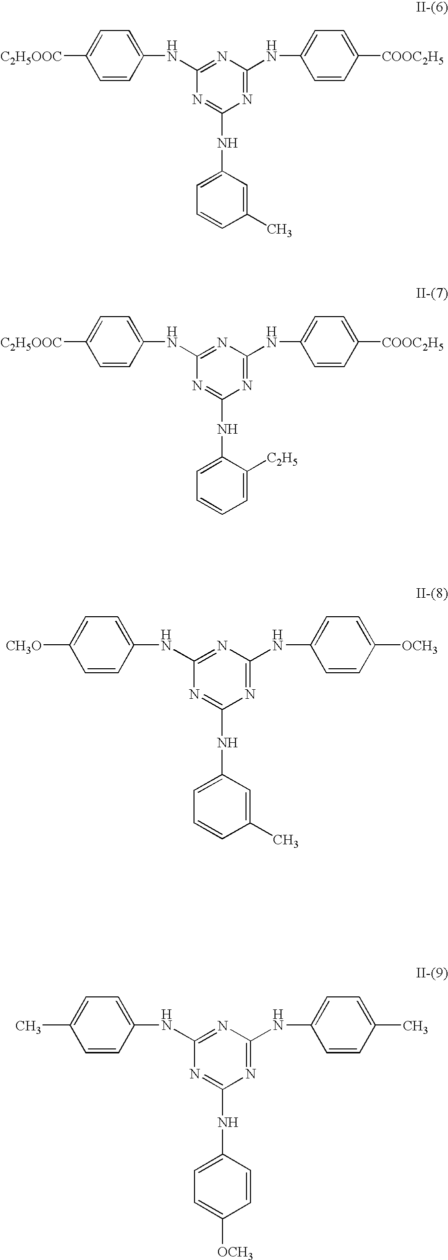

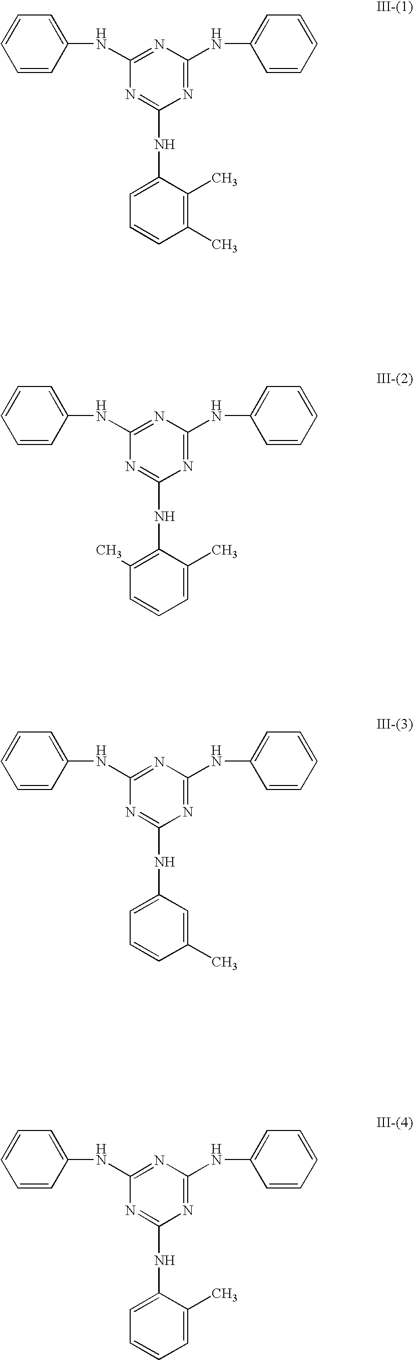

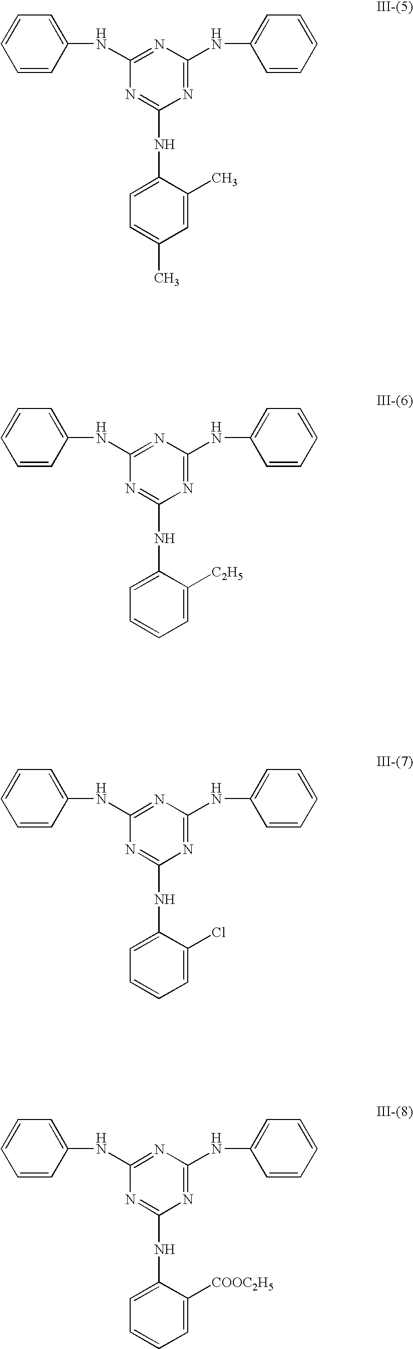

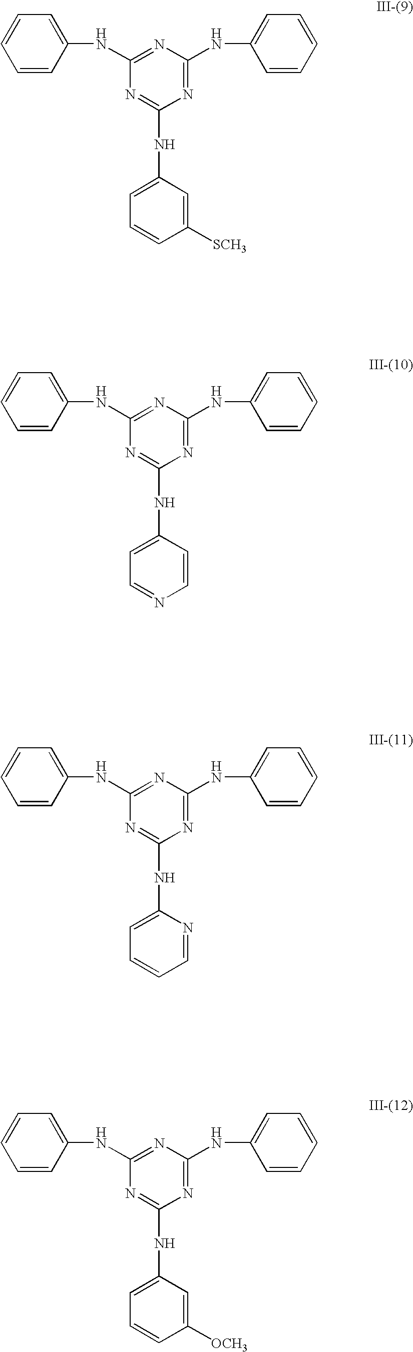

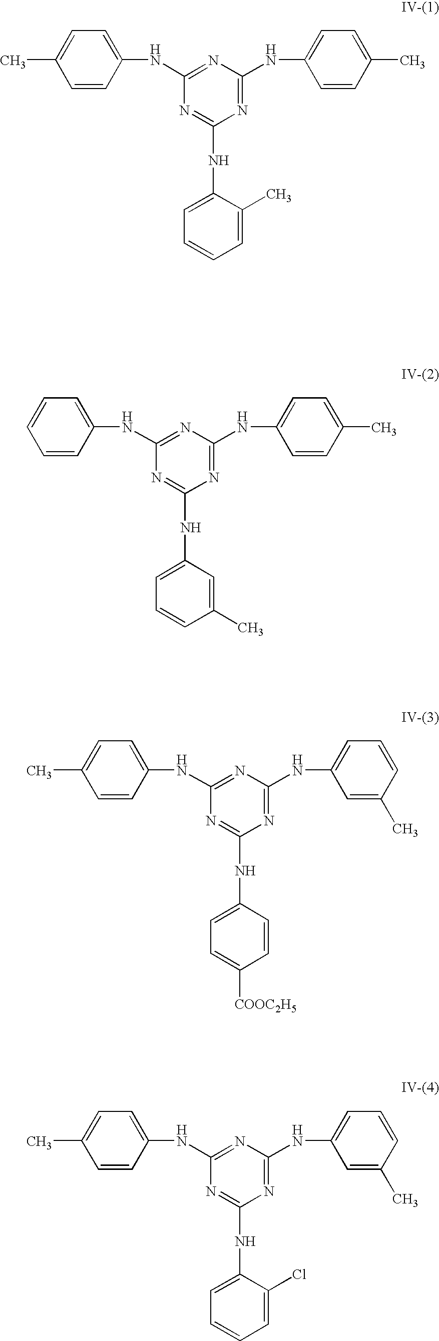

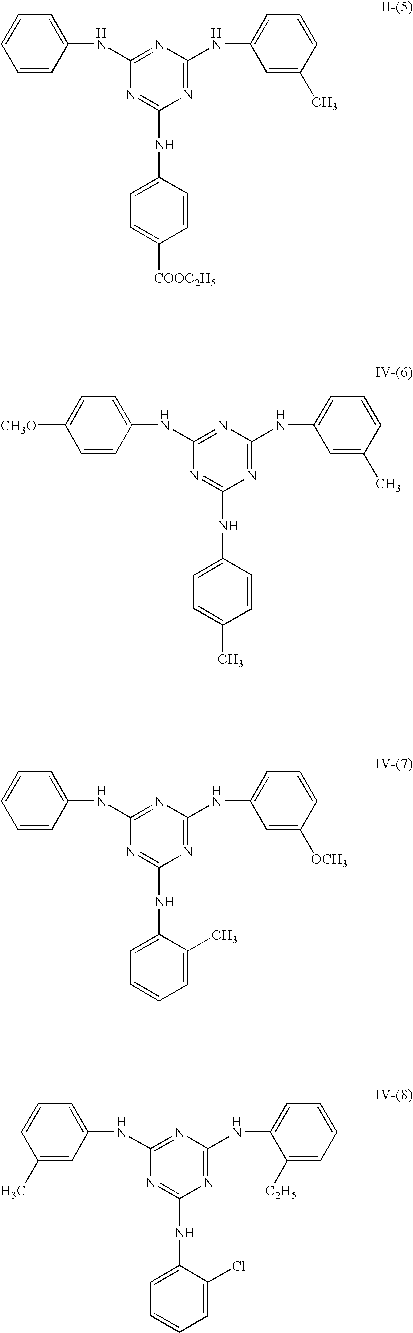

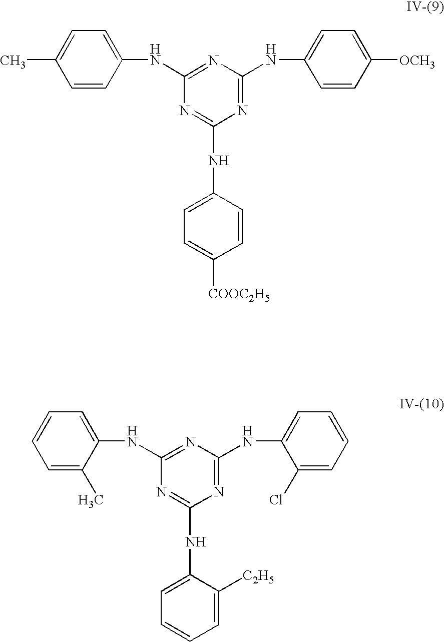

The aromatic compound of the present invention is useful as a retardation increasing agent for an optical film. One type of aromatic compound represented by Formulae (I) to (IV) above may be used singly, or two or more types may be used in combination. Furthermore, it may be used in combination with a homopolymer or copolymer having a 1,3,5-triazine ring.

A UV absorbing agent may be used in combination with the aromatic compound of the present invention. The amount of UV absorbing agent used is preferably at most 10% as a proportion by weight relative to the compound of the present invention, and more preferably at most 3%.

(Cellulose Acylate)

The cellulose acylate used in the cellulose acylate film and the production process therefor of the present invention are now explained in detail. The cellulose acylate used in the present invention is not particularly limited as long as the effects of the present invention are exhibited. In the present invention, two or more different types of cellulose acylates may be used as a mixture. However, thereamong, examples of preferred cellulose acylates are the materials below. That is, the cellulose acylates satisfy all the expressions (I) to (III) with regard to the degree of substitution of hydroxyl groups on the cellulose.
2.6≦SA+SB≦3.0 (I)
2.0≦SA≦3.0 (II)
0≦SB≦0.8 (III)

In the expressions, SA and SB denote acyl group substituents on hydroxyl groups of cellulose, SA is the degree of substitution for an acetyl group, and SB is the degree of substitution for an acyl group having 3 to 22 carbon atoms.

β-1,4 Bonding glucose units constituting cellulose have free hydroxyl groups at the 2-, 3-, and 6-positions. The cellulose acylate is a polymer formed by esterifying a part or the whole of these hydroxyl groups with an acyl group. The degree of acyl substitution means the proportion of esterified groups at each of the 2-, 3-, and 6-positions of the cellulose (100% esterification is a degree of substitution of 1). In the present invention, the sum total of the degrees of substitution of SA and SB of hydroxyl groups is preferably 2.7 to 2.96, and particularly preferably 2.80 to 2.95. Furthermore, the degree of substitution of SB is preferably 0 to 0.8, and particularly preferably 0 to 0.6. Moreover, 28% or more of SB is a substituent at the 6-hydroxyl group, preferably 30% or more thereof is a substituent at the 6-hydroxyl group, more preferably 31%, and particularly preferably 32% or more thereof is a substituent at the 6-hydroxyl group. Furthermore, a cellulose acylate film in which the sum total of the degrees of substitution of SA and SB at the 6-position of the cellulose acylate is at least 0.8, more preferably 0.85, and particularly preferably 0.90, can also be cited.

The acyl group (SB) having 3 to 22 carbon atoms in the cellulose acylate used in the present invention may be an aliphatic group or an aryl group, and is not particularly limited. It is, for example, an alkylcarbonyl ester, an alkenylcarbonyl ester, an aromatic carbonyl ester, or an aromatic alkylcarbonyl ester of cellulose, which may further have a substituent. Preferred SBs thereof include propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl groups. Thereamong, preferred SBs are propionyl, butanoyl, dodecanoyl, octadecanoyl, t-butanoyl, oleoyl, benzoyl, naphthylcarbonyl, and cinnamoyl.

One aspect of the present invention is a cellulose acetate film containing a functional additive (Re adjusting agent, UV absorbing agent, etc.) that is soluble in an organic solvent and that preferably has a degree of acetylation of 57.0% to 62.5%, wherein exudation of the additive, which easily occurs under certain drying conditions, has been improved by a solvent composition during solution preparation. In the detailed explanation of the present invention below, cellulose acetate is explained as a representative example of the cellulose acylate. However, the present invention can of course be applied broadly to a process for producing a cellulose acylate.

With regard to the ‘additive’ in the present invention, a functional additive is preferred. The ‘functional additive’ referred to here means an additive (Re adjusting agent, UV absorbing agent, etc.) that can control, improve, or change the optical properties of the cellulose acylate film, and an additive other than a plasticizer.

Another aspect of the present invention is to suppress exudation of the additive, which easily occurs under certain drying conditions, by increasing the stabilization energy of the additive.

(Cellulose Acetate Film)

In the present invention, a cellulose acetate film is preferably used and, more specifically, a cellulose acetate having a degree of acetylation of 57.0% to 62.5% is preferably used. It is more preferable to use a cellulose acetate having a degree of acetylation in the range of 58.0% to 62.0%, and particularly preferably 59.0% to 61.5%.

The degree of acetylation referred to here means the amount of acetic acid bonded per unit weight of cellulose. With regard to the degree of acetylation, the degree of acetylation is measured and calculated in accordance with ASTM: D-817-91 (a test method for cellulose acetate, etc.)

The viscosity average degree of polymerization (DP) of the cellulose ester is preferably at least 250, and more preferably at least 290.

The cellulose acetate used in the present invention preferably has a narrow molecular weight distribution Mw/Mn (Mw is the weight average molecular weight, Mn is the number average molecular weight) obtained by gel permeation chromatography. The specific value for Mw/Mn is preferably in the range of 1.0 to 1.7, more preferably in the range of 1.3 to 1.65, and most preferably in the range of 1.4 to 1.6.

In the present invention, a cellulose acetate film having a light transmittance of 80% or more is preferably used.

The cellulose acetate used in the present invention mainly contains an additive such as an additive (retardation control agent) in order for it to exhibit the optical properties as described later or a plasticizer for improving the mechanical physical properties. The retardation control agent is defined here as a UV absorbing agent in a broad sense, and when it particularly means an additive that exhibits optical properties, it is expressed as a retardation control agent.

Such a cellulose acylate and functional additive (UV absorbing agent, retardation control agent) are dissolved in a solvent, and a cellulose acylate solution of the present invention can be achieved by the following method. That is, the point of the present invention is that it has been found that weeping occurs when the solvent composition changes during drying, thus decreasing the solubility of the functional additive and destabilizing the functional additive in the system.

In order to suppress the exudation when the solvent composition changes during drying, the solubility in the solvent composition estimated from a solubility test of the additive alone (result after 4 days at temperature equilibrium) should be as high as possible. By so doing, even if the solvent composition changes during drying, the additive can be present stably in the system, thus suppressing weeping.

The solubility can be adjusted by the solvent composition when preparing a concentrated solution (dope), by the type of additive, and by the temperature. By appropriately adjusting the composition of methylene chloride and methanol, even when the solvent composition changes during drying, the additive can be present stably in the solvent, thus suppressing weeping.

Such a cellulose acylate and an additive (plasticizer, UV agent, retardation control agent) are dissolved in a solvent, and in order to suppress exudation of the additive, the present invention satisfies the following requirements.

(1) Dissolution is carried out such that the heat of solution (ΔH0) generated when dissolving the additive in an organic solvent is larger than the heat of solution (ΔH1) generated when dissolving the additive in a solution in which the cellulose acylate has been dissolved in the organic solvent. The heat of solution (amount of heat absorption) being large means that the absolute value of ΔH is large. The heat of solution ΔH0 is the amount of heat (heat absorption) required when the solvent dissolves the additive, and the heat of solution ΔH1 being smaller than ΔH0 suggests that the additive dissolves in the solvent and at the same time is stabilized by the cellulose acylate. The degree of stabilization can be expressed as ΔH0−ΔH1. That is, the higher the degree of stabilization, the stronger the interaction between the additive and the cellulose acylate, and the more the exudation is suppressed.

(2) Dissolution is carried out such that the heat of solution (ΔH0) generated when dissolving an additive 1 (retardation control agent) in an organic solvent is larger than the heat of solution (ΔH1) generated when dissolving the additive 1 in a solution in which an additive 2 (plasticizer) has been dissolved in the organic solvent. The heat of solution (amount of heat absorption) being large means that the absolute value of ΔH is large. The heat of solution ΔH0 is the amount of heat (heat absorption) required when the solvent dissolves the additive, and the heat of solution ΔH1 being smaller than ΔH0 suggests that the additive dissolves in the solvent and at the same time is stabilized by the additive 2 (plasticizer). The degree of stabilization can be expressed as ΔH0−ΔH1. That is, the higher the degree of stabilization, the stronger the interaction between the additive and the additive 2 (plasticizer), and the more the exudation is suppressed.

(3) Dissolution is carried out such that the heat of solution (ΔH0) generated when dissolving an additive 1 (retardation control agent) in an organic solvent is larger than the heat of solution (ΔH1) generated when dissolving the additive 1 in a solution in which a cellulose acylate and an additive 2 (plasticizer) have been dissolved in the organic solvent. The heat of solution (amount of heat absorption) being large means that the absolute value of ΔH is large. The heat of solution ΔH0 is the amount of heat (heat absorption) required when the solvent dissolves the additive, and the heat of solution ΔH1 being smaller than ΔH0 suggests that the additive 1 dissolves in the solvent and at the same time is stabilized by the cellulose acylate and the additive 2. The degree of stabilization can be expressed as ΔH0−ΔH1. That is, the higher the degree of stabilization, the stronger the interactions of the additive with the cellulose acylate and the additive 2, and the more the exudation is suppressed.

A cellulose acylate solution having such properties can be achieved by the following method. That is, the point of the present invention is that it has been found that the stabilization energy estimated by the heat of solution depends on the solvent composition and the type of additive, and the weeping can be improved by adjustment thereof.

In order to suppress the exudation, the degree of stabilization (ΔH0−ΔHs) estimated from the heat of solution is at least 0.3 kcal/mol, more preferably at least 0.6 kcal/mol, and more preferably at least 1 kcal/mol. Factors for stabilizing the retardation control agent may be any of the cellulose acylate and the additive such as the plasticizer or a matting agent. It is advantageous for the solution system to carry out stabilization by several kinds of means rather than by one kind.

The degree of stabilization can be adjusted by the solvent composition when preparing a concentrated solution (dope) and by the type of additive. By appropriately adjusting the composition of methylene chloride and methanol, the cellulose acylate can be present stably in the solvent and the additive can be stabilized. Furthermore, when the solvent composition changes while casting the dope on a band and drying, the longer the residence time in the solvent composition which gives a high degree of stabilization, the higher the degree of stabilization, thus suppressing the weeping.

(Haze)

The haze of a film is calculated in accordance with the equation below, and the haze is preferably 2.0% or less, more preferably 1.0% or less, and most preferably 0.6% or less.
Haze (HZ)=Diffusion (D)/Overall transmittance(T)×100 (%)
(Retardation of Film)

The retardation value Re and the retardation value Rth of a film are defined as in Equations (I) and (II) below.
retardation value Re=(nx−ny)×d Equation (I)
retardation value Rth={(nx+ny)/2−nz}×d Equation (II)

In Equations (I) and (II), nx denotes the refractive index in the direction of the phase retardation axis within the film (direction in which the refractive index is maximum), ny denotes the refractive index in the direction of the phase advance axis within the film (direction in which the refractive index is minimum), nz is the refractive index in the film thickness direction, and d denotes the thickness of the film in units of nm.

In the present invention, the retardation value Re of the cellulose ester film is adjusted so as to be in the range of 0 to 100 nm, and the retardation value Rth is adjusted so as to be in the range of 20 to 400 nm, and preferably in the range of 40 to 200 nm.

The birefringence (Δn: nx−ny) of the cellulose ester film is preferably in the range of 0.00 to 0.002. The birefringence {(nx+ny)/2−nz} of the cellulose ester film in the thickness direction is preferably in the range of 0.001 to 0.05.

The cellulose acetate film having the above-mentioned optical properties can be produced using the materials described below.

(Production of Cellulose Acetate Film)

The cellulose acetate film is preferably produced by a solvent cast method. In the solvent cast method, a film is produced using a solution (dope) in which cellulose acetate has been dissolved in an organic solvent.

The production of the cellulose acylate film of the present invention is specifically explained with reference to cellulose acetate as an example.

(Mixed Solvent Containing Halohydrocarbon)

Although the production process of the present invention can be applied to a mixed solvent containing a chlorohydrocarbon and a mixed solvent containing no chlorohydrocarbon, it can preferably be applied to a mixed solvent containing a chlorohydrocarbon.

With regard to the former mixed solvent, a mixed solvent containing solvents selected from a lower alcohol having 1 to 4 carbon atoms, an ether having 3 to 12 carbon atoms, a ketone having 3 to 12 carbon atoms, an ester having 3 to 12 carbon atoms, and a halohydrocarbon having 1 to 6 carbon atoms is preferable. The ether, the ketone, and the ester may have a cyclic structure. A compound having two or more functional groups such as ether, ketone, and ester (that is, —O—, —CO—, and —COO—) can be also used as an organic solvent. The organic solvent may have another functional group such as an alcoholic hydroxyl group. In the case of an organic solvent having two or more types of functional groups, the number of carbon atoms thereof is preferably 3 to 6 for one containing a halogen group, and 3 to 12 for one containing no halogen group.

Examples of the lower alcohol having 1 to 4 carbon atoms include methanol, ethanol, and butanol. Thereamong, methanol is preferred. Examples of the ether having 3 to 12 carbon atoms include diisopropyl ether, dimethoxymethane, dimethoxyethane, 1,4-dioxane, 1,3-dioxolane, tetrahydrofuran, anisole, and phenetole. Examples of the ketone having 3 to 12 carbon atoms include acetone, methyl ethyl ketone, diethyl ketone, diisobutyl ketone, cyclohexanone, and methylcyclohexanone. Examples of the ester having 3 to 12 carbon atoms include ethyl formate, propyl formate, pentyl formate, methyl acetate, ethyl acetate, and pentyl acetate.

Examples of the organic solvent having two or more types of functional groups include 2-ethoxyethyl acetate, 2-methoxyethanol, and 2-butoxyethanol.

The number of carbon atoms of the halohydrocarbon is preferably 1 or 2, and most preferably 1. The halogen of the halohydrocarbon is preferably chlorine. The proportion of the hydrogen atoms of the halohydrocarbon replaced with a halogen is preferably 25 to 75 mol %, more preferably 30 to 70 mol %, yet more preferably 35 to 65 mol %, and most preferably 40 to 60 mol %. Methylene chloride is a representative halohydrocarbon. Two or more types of organic solvents may be used as a mixture.

(Mixed Solvent Containing No Halohydrocarbon)

For dissolving the cellulose acylate used in the present invention, a mixed solvent containing no halohydrocarbon such as a chlorohydrocarbon can also be used. This so-called non-chlorine system mixed organic solvent is selected from various viewpoints, and it is preferably as follows. That is, a preferred solvent for the cellulose acylate of the present invention is a mixed solvent of at least three different types (a first solvent, a second solvent, and a third solvent), the first solvent is at least one type selected from methyl acetate, ethyl acetate, methyl formate, ethyl formate, acetone, dioxolane, and dioxane or a mixed solvent thereof, the second solvent is selected from a ketone having 4 to 7 carbon atoms and an acetoacetic acid ester, and the third solvent is selected from an alcohol or hydrocarbon having 1 to 10 carbon atoms, and is more preferably an alcohol having 1 to 8 carbon atoms. When the first solvent is a mixed solvent of two or more types of solvents, the second solvent may be omitted. The first solvent is more preferably methyl acetate, acetone, methyl formate, ethyl formate, or a mixture thereof, and the second solvent is preferably methyl ethyl ketone, cyclopentanone, cyclohexanone, or methyl acetylacetate, or may be a mixed solvent thereof.

Preferred alcohols or hydrocarbon as the third solvent may be straight, branched, or cyclic chain, and thereamong a saturated aliphatic hydrocarbon is preferable. The hydroxyl group of the alcohol may be any of primary to tertiary. Examples of the alcohol include methanol, ethanol, 1-propanol, 2-propanol, 1-butanol, 2-butanol, t-butanol, 1-pentanol, 2-methyl-2-butanol, and cyclohexanol. A fluoroalcohol can also be used as an alcohol. Examples thereof include 2-fluoroethanol, 2,2,2-trifluoroethanol, and 2,2,3,3-tetrafluoro-1-propanol. Furthermore, the hydrocarbon may be straight, branched, or cyclic chain. Either an aromatic hydrocarbon or an aliphatic hydrocarbon can be used. The aliphatic hydrocarbon may be saturated or unsaturated. Examples of the hydrocarbon include cyclohexane, hexane, benzene, toluene, and xylene. The alcohol and the hydrocarbon as the third solvent may be used singly or as a mixture of two or more types, and are not particularly limited. Specific preferred compounds as the third solvent include methanol, ethanol, 1-propanol, 2-propanol, 1-butanol, 2-butanol, cyclohexanol, cyclohexane, and hexane, and particularly methanol, ethanol, 1-propanol, 2-propanol, and 1-butanol.

With regard to the above-mentioned mixture of three types of solvents, the first solvent is preferably contained at 20 to 95 wt %, the second solvent at 2 to 60 wt %, and the third solvent at 2 to 30 wt %, and more preferably the first solvent is contained at 30 to 90 wt %, the second solvent at 3 to 50 wt %, and the third solvent at 3 to 25 wt %. Particularly preferably, the first solvent is contained at 30 to 90 wt %, the second solvent at 3 to 30 wt %, and the third solvent is an alcohol and is contained at 3 to 15 wt %. When the first solvent is a mixed solvent and the second solvent is not used, the first solvent is preferably contained at 20 to 90 wt % and the third solvent at 5 to 30 wt %, and more preferably the first solvent is contained at 30 to 86 wt % and the third solvent at 7 to 25 wt %. The above-mentioned non-chlorine system organic solvents used in the present invention are described in detail in ‘Hatsumei Kyokai Koukai Giho (Journal of Technical Disclosure)’ (Technical Disclosure No. 2001-1745, published Mar. 15, 2001, Japan Institute of Invention and Innovation), pp. 12 to 16.

The cellulose acetate solution can be prepared by a standard method. The standard method means preparation involving a treatment at a temperature of 0° C. or higher (room temperature or high temperature). Preparation of the solution can be carried out using a dope preparation method and equipment in a normal solvent cast method. In the case of the standard method, it is preferable to use a halohydrocarbon (especially methylene chloride) as an organic solvent.

The amount of cellulose acetate is adjusted so that it is contained at 10 to 40 wt % in the solution obtained. The amount of cellulose acetate is preferably 10 to 30 wt %. Any of the additives that will be described later may be added to the organic solvent (main solvent).

The solution can be prepared by stirring cellulose acetate and the organic solvent at room temperature (0 to 40° C.). A high concentration solution may be stirred under pressure and with heating. Specifically, cellulose acetate and the organic solvent are placed in a pressure vessel and hermetically sealed, and stirred under pressure while heating at a temperature in the range from the boiling point of the solvent at normal pressure and a temperature at which the solvent does not boil.

The heating temperature is usually 40° C. or higher, preferably 60° C. to 200° C., and more preferably 80° C. to 110° C.

The components may be roughly mixed beforehand and then placed in the vessel. Alternatively, they may be placed in the vessel in sequence. The vessel has to be constituted so that stirring is possible. The vessel can be pressurized by injecting an inert gas such as nitrogen gas. Furthermore, an increase in the vapor pressure of the solvent due to the heating may be utilized. Alternatively, after the vessel is hermetically sealed, each component may be added under pressure.

When heating, it is preferable to heat the vessel externally. For example, a jacket type heating device may be used. Alternatively, a plate heater can be provided on an outer part of the vessel, and the entire vessel can be heated by circulating a liquid through a pipeline.

It is preferable to provide a stirrer blade within the vessel, and stirring is carried out therewith. The stirrer blade preferably has a length such that it can reach the vicinity of the vessel wall. A scraper blade is preferably provided at the extremity of the stirring blade so as to renew the liquid film on the vessel wall.

The vessel may be equipped with instruments such as a pressure gauge and a thermostat. Each component is dissolved in the solvent in the vessel. The dope thus prepared is taken out of the vessel after cooling, or taken out and then cooled using a heat exchanger, etc.

The solution can be prepared by a cooling dissolution method. In the cooling dissolution method, cellulose acetate can be dissolved in an organic solvent in which it is difficult for it to dissolve by a normal dissolution method. As an organic solvent for cellulose acetate, methylene chloride is generally used. Even for a solvent in which cellulose acetate can be dissolved by a normal dissolution method, the cooling dissolution method has the effect of enabling a uniform solution to be obtained quickly.

In the cooling dissolution method, cellulose acetate is firstly added gradually to an organic solvent while stirring at room temperature.

The amount of cellulose acetate is preferably adjusted so that it is contained at 10 to 40 wt % in the mixture. The amount of cellulose acetate is preferably 10 to 30 wt %. Furthermore, any of the additives that will be described later may be added to the mixture.

The mixture is then cooled to −100° C. to −10° C. (preferably −80° C. to −10° C., more preferably −50° C. to −20° C., and most preferably −50° C. to −30° C.). Cooling can be carried out in, for example, a dry ice-methanol bath (−75° C.) or a cooled diethylene glycol solution (−30° C. to −20° C.). By so doing, the mixture of cellulose acetate and the organic solvent solidifies.

The cooling rate is preferably 4° C./min or higher, more preferably 8° C./min or higher, and most preferably 12° C./min or higher. The higher the cooling rate, the more preferable it is, but 10,000° C./sec is the theoretical upper limit, 1,000° C./sec is the technical upper limit, and 100° C./sec is the practical upper limit. The cooling rate is the value obtained by dividing the difference between the temperature when starting cooling and the final cooling temperature by the time taken from starting the cooling until the final cooling temperature is attained.

Heating this further to 0° C. to 200° C., preferably 0° C. to 150° C., more preferably 0° C. to 120° C., and most preferably 0° C. to 50° C. dissolves the cellulose acetate in the organic solvent. Increasing the temperature can be carried out by simply allowing it to stand at room temperature or by heating it in a hot bath.

The heating rate is preferably 4° C./min or higher, more preferably 8° C./min or higher, and most preferably 12° C./min or higher. The higher the heating rate, the more preferable it is; 10000° C./sec is the theoretical upper limit, 1000° C./sec is the technical upper limit, and 100° C./sec is the practical upper limit. The heating rate is the value obtained by dividing the difference between the temperature when starting heating and the final heating temperature by the time taken from starting the heating until the final heating temperature is attained.

As described above, a uniform solution can be obtained. When dissolution is inadequate, the cooling and heating procedures may be repeated. Whether or not the dissolution is adequate can be judged by visually inspecting the appearance of the solution.

In the cooling dissolution method, in order to prevent water contamination due to condensation during cooling, it is desirable to use a hermetically sealable vessel. Furthermore, in the cooling and heating procedures, applying pressure during cooling and evacuating during heating can reduce the dissolution time. In order to carry out the application of pressure and the evacuation, it is desirable to use a pressure-resistant vessel.

A 20 wt % solution in which cellulose acetate (degree of acetylation: 60.9%, viscosity average degree of polymerization: 299) is dissolved in methyl acetate by the cooling dissolution method has a pseudo-phase transition point between a sol state and a gel state in the vicinity of 33° C. according to measurement by differential scanning calorimetry (DSC), and is in a uniform gel state at a temperature below the above point. It is therefore preferable to maintain the solution at the pseudo-phase transition temperature or higher, and more preferably at a temperature that is about 10° C. higher than the gel phase transition temperature. However, this pseudo-phase transition temperature varies depending on the degree of acetylation of cellulose acetate, the viscosity average degree of polymerization, the concentration of the solution, and the organic solvent used.

The cellulose acetate solution (dope) thus prepared is subjected to the solvent cast method to produce the cellulose acetate film. In the present invention, the aforementioned retardation increasing agent is added to the dope.

The dope is cast on a drum or a band, and the solvent is evaporated to form a film. The concentration of the dope prior to the casting is preferably adjusted so that the solids content thereof is 18 to 35%. The surface of the drum or band is preferably finished to a mirror-smooth state.

The dope is preferably cast on a drum or band whose surface temperature is 10° C. or lower. Drying is preferably carried out by blowing for 2 sec or longer after casting.

The drying prior to peel-off referred to in the present invention means drying after the dope is applied on the band or the drum up until it is peeled off as a film. The first half denotes a process prior to half of the whole time required from the dope application to peeling-off. The drying prior to peel-off can be carried out by blowing an inert gas. The blowing temperature in the drying prior to peel-off is preferably 0° C. to 180° C., and more preferably 40° C. to 150° C. The effective wind speed referred to in the present invention denotes the average wind speed at the position above the surface of the film by 5 cm measured by means of an air velocity meter (Anemomaster: KANOMAX JAPAN, INC.). The effective blowing dry wind speed in the first half of the drying prior to peel-off is preferably 20 to 800 m/min, and more preferably 50 to 500 m/min. The blowing dry may be carried out continuously during the drying prior to peel-off, or there may be calm conditions in a part of the process. When the drying prior to peel-off is too severe, problems such as bubbling might occur, but drying as quickly as possible while preventing the occurrence of such problems and quickly fixing the retardation increasing agent within the cellulose ester can give an even film.

The film thus obtained is peeled off from the drum or band, and can be further subjected to drying by high temperature blowing in which the temperature is changed stepwise from 100° C. to 160° C., thus evaporating any residual solvent. The above-mentioned method is described in JP-B-5-17844. According to this method, the dope gels at the surface temperature of the drum or band during casting, thus enabling the time from casting to peel-off to be reduced.

The casting and drying methods in the solvent cast method are described in detail in ‘Hatsumei Kyokal Koukai Giho (Journal of Technical Disclosure)’ (Technical Disclosure No. 2001-1745, published Mar. 15, 2001, Japan Institute of Invention and Innovation), pp. 25 to 30, and can be classified into casting (including co-casting), metal support, drying, peeling-off, drawing, etc.

The drying method of the solvent cast method is described also in U.S. Pat. Nos. 2,336,310, 2,367,603, 2,492,078, 2,492,977, 2,492,978, 2,607,704, 2,739,069, and 2,739,070, GB Pat. Nos. 640731 and 736892, JP-B-45-4554, JP-B49-5614, JP-A-60-176834, JP-A-60-203430, and JP-A-62-115035.

A film can be formed by casting two or more layers using the cellulose acetate solution (dope) prepared above. In this case, the cellulose acetate film is preferably formed by the solvent cast method. The dope is cast on a drum or a band, and the solvent is evaporated to form a film. The concentration of the dope prior to casting is preferably adjusted so that the solids content thereof is 10% to 40%. The surface of the drum or band is preferably finished to a mirror-smooth state.

When the cellulose acetate solution is cast using a plurality of, that is, two or more cellulose acetate solutions, a film may be formed by casting solutions containing cellulose acetate through a plurality of casting orifices, arranged at intervals in the direction of travel of the support, so as to form layers (ref. JP-A-61-158414, JP-A-1-122419, JP-A-11-198285).

A film can also be formed by casting cellulose acetate solutions though two casting orifices (ref. JP-B-60-27562, JP-A-61-94724, JP-A-6-134933).

Alternatively, a method for casting the cellulose acetate film involving simultaneous extrusion of high and low viscosity cellulose acetate solutions, the flow of the high viscosity cellulose acetate solution being surrounded by the low viscosity cellulose acetate solution, can also be used (ref. JP-A-56-162617).

Alternatively, two casting orifices are used, a film formed on a support through a first casting orifice is peeled off, and a second casting is carried out on the surface that has been in contact with the support surface, thus forming a film (ref. JP-B-44-20235).

The cellulose acetate solutions that are to be cast may be identical solutions or they may be different cellulose acetate solutions, and they are not particularly limited. In order to impart functionality to a plurality of cellulose acetate layers, cellulose acetate solutions according to the functionality may be extruded through the corresponding casting orifices.

Furthermore, another functional layer (e.g., an adhesive layer, a dye layer, an antistatic layer, an anthalation layer, a UV absorbing layer, a polarizing layer, etc.) may be cast simultaneously with this cellulose acetate solution.

A phase difference film of the present invention can be produced by laminating a layer containing a small amount of an additive (hereinafter, called an ‘outer layer’) on the outside of a layer containing a large amount of the additive (hereinafter, called an ‘inner layer’) by a co-casting method or a sequential casting method on the cellulose acetate film. The outer layer may be provided on only one side of the inner layer, or on both sides thereof.

The types of cellulose acetate in the inner layer and the outer layer may be the same or different from each other.

The thickness of the outer layer is preferably 0.2 to 50 μm, more preferably 0.5 to 20 μm, and particularly preferably 0.5 to 5 μm.

A casting device is, for example, an internal confluence die or a tip confluence die for co-casting, or an extrusion die for sequential casting.

When employing a single layer solution, in order to obtain a required film thickness it is necessary to extrude a high concentration and high viscosity cellulose acetate solution. In this case, the stability of the cellulose acetate solution is poor, solids are generated, and problems such as particulates faults and poor flatness are often caused. In order to solve these problems, by casting a plurality of cellulose acetate solutions through casting orifices, high viscosity solutions can be extruded simultaneously onto a support, and not only can a film having an excellent surface condition with improved flatness be formed, but also the use of thick cellulose acetate solutions can reduce the drying load, thus enabling the speed with which the film is produced to be increased.

In order to improve the mechanical physical properties or increase the drying speed, the cellulose acetate film can employ a plasticizer such as a phosphate ester or a carboxylate ester.

Examples of the above-mentioned phosphate ester include triphenyl phosphate (TPP), biphenyl diphenyl phosphate (BDP), and tricresyl phosphate (TCP). Representative examples of the above-mentioned carboxylate ester include a phthalate ester and a citrate ester. Examples of the phthalate ester include dimethyl phthalate (DMP), diethyl phthalate (DEP), dibutyl phthalate (DBP), dioctyl phthalate (DOP), diphenyl phthalate (DPP), and diethyl hexyl phthalate (DEHP). Examples of the citrate ester include triethyl O-acetylcitrate (OACTE) and tributyl O-acetylcitrate (OACTB). Examples of other carboxylate esters include butyl oleate, methyl acetyl ricinoleate, dibutyl sebacate, and various esters of trimellitic acid. Phthalate ester system plasticizers (DMP, DEP, DBP, DOP, DPP, DEHP) are preferably used, and DEP and DPP are particularly preferable.

The amount of plasticizer added is preferably 0.1 to 25 wt % of the amount of cellulose acetate, more preferably 1 to 20 wt %, and most preferably 3 to 15 wt %.

The cellulose acetate film may contain a degradation inhibitor (e.g., an antioxidant, a peroxide decomposition agent, a radical inhibitor, a metal deactivator, an acid scavenger, or an amine) (ref. JP-A-3-199201, JP-A-5-197073, JP-A-6-107854).

The amount of degradation inhibitor added is preferably 0.01 to 1 wt % of the solution (dope) that is to be prepared, and more preferably 0.01 to 0.2 wt %. If the amount thereof added is less than 0.01 wt %, then the effects of the degradation inhibitor are hardly recognized. If the amount thereof added exceeds 1 wt %, bleed-out (exudation) of the degradation inhibitor on the film surface might be observed. Examples of particularly preferred degradation inhibitors include butylated hydroxytoluene (BHT) and tribenzylamine (TBA).

The cellulose acetate film may be provided on one side or on both sides thereof with a mat layer containing a matting agent and a polymer in order to improve the ease of handling during production. With regard to the matting agent and the polymer, those described in JP-A-10-44327 can suitably be used.

The matting agent may be mixed into the dope.

Furthermore, various additives may be added to the cellulose acetate solution as necessary in any stage before and after preparation of the solution. Examples of the additives include, in addition to a functional additive such as a UV absorbing agent, inorganic fine particles such as silica, kaolin, talc, diatomaceous earth, quartz, calcium carbonate, barium sulfate, titanium oxide, and alumina, a thermal stabilizer such as a salt of an alkaline earth metal like calcium or magnesium, an antistatic agent, a flame retardant, a lubricant, and an oil.

Moreover, in order to reduce the load during peel-off, a peeling promoter may be added. A surfactant is effective therefor; the surfactant is not particularly limited and includes a phosphoric acid type, a sulfonic acid type, a carboxylic acid type, a nonionic type, and a cationic type (ref. JP-A-61-243837).

(Biaxial Drawing)

The cellulose acetate film may be subjected to drawing in order to alleviate potential distortion. Since drawing can alleviate the potential distortion in the drawing direction, in order to alleviate distortion in every direction within the film, biaxial drawing may be carried out.

With regard to the biaxial drawing, there are a simultaneous biaxial drawing method and a sequential biaxial drawing method; from the viewpoint of continuous production, the sequential biaxial drawing method is preferable, and after casting the dope, the film is peeled off from the band or drum, drawn in its width direction (or longitudinal direction) and then drawn in its longitudinal direction (or width direction).

A method for drawing in the width direction is described in, for example, JP-A-62-115035, JP-A-4-152125, JP-A-4-284211, JP-A-4-298310, and JP-A-11-48271. The film is drawn at room temperature or with heating. The heating temperature is preferably at a glass transition temperature of the film or lower. The film can be drawn during the drying process, and this is particularly effective when there is residual solvent. When drawing in the longitudinal direction, for example, the film can be drawn by adjusting the speed of film transport rollers so that the speed at which the film is wound is faster than the speed at which the film is peeled off. When drawing in the width direction, the film is transported while holding its width by means of a tenter, and the film can be drawn by gradually increasing the width of the tenter. It is also possible to carry out drawing using a drawing machine after drying the film (preferably monoaxial drawing using a long drawing machine). The draw ratio of the film (proportion of the increase by drawing relative to the original length) is preferably in the range of 5% to 50%, more preferably in the range of 10% to 40%, and most preferably in the range of 15% to 35%.

These steps from casting to post drying may be carried out under an atmosphere of air or under an atmosphere of an inert gas such as nitrogen gas. A winder used in the production of the cellulose acetate film used in the present invention is one that is generally used, and winding can be carried out by a winding method such as a constant tension method, a constant torque method, a taper tension method, or a programmed tension control method employing constant internal stress.

(Surface Treatment for Cellulose Acetate Film)

The cellulose acetate film may be subjected to a surface treatment. Specific methods therefor include a corona discharge treatment, a glow discharge treatment, a flame treatment, an acid treatment, an alkali treatment, and a UV irradiation treatment. Furthermore, as described in JP-A-7-333433, an undercoat layer may be preferably provided.

From the viewpoint of the maintenance of film flatness, in these treatments the temperature of the cellulose acetate film is preferably at most the Tg (glass transition temperature), and specifically at most 150° C.

When the film is used as a transparent protective film for a polarizing plate, from the viewpoint of adhesion to a polarizing film, it is particularly preferable to carry out the acid treatment or the alkali treatment, and more preferably the alkali treatment.

The alkali treatment (hereinafter, also called ‘saponification treatment’) is explained in detail below as an example.

The alkali treatment for the cellulose acetate film is preferably carried out in a cycle involving dipping the film surface in an alkaline solution, then neutralizing with an acidic solution, washing with water, and drying.

Examples of the alkaline solution include a potassium hydroxide solution and a sodium hydroxide solution, and the hydroxide ion normality is preferably 0.1 to 3.0 N, and more preferably in the range of 0.5 to 2.0 N. The temperature of the alkaline solution is preferably in the range of room temperature to 90° C., and more preferably in the range of 40° C. to 70° C.

The alkaline solution may be an aqueous solution or an organic solvent. In the case of an organic solvent, a lower alcohol is preferable, an alcohol or glycol having 1 to 5 carbon atoms is more preferable, and ethanol, n-propanol, iso-propanol, butanol, ethylene glycol, and propylene glycol are yet more preferable. iso-Propanol and propylene glycol are yet more preferable. They may be used as a mixture. Furthermore, water or a surfactant may be added thereto.

As preferred examples, those in which an alkali is dissolved in the solutions below can be cited
iso-Propanol/propylene glycol/water (ratio by volume: 70/15/15)
iso-Propanol/water (ratio by volume: 85/15)
iso-Propanol/propylene glycol (ratio by volume: 85/15)
iso-Propanol

Dipping in these alkaline solutions or coating (bar coating, curtain coating, etc.) is also possible.

The surface energy is preferably 55 mN/m or higher, and more preferably 60 mN/m or higher and 75 mN/m or lower.

The surface energy of a solid can be determined by a contact angle method, a heat of wetting method, or an adsorption method as described in ‘Nure no kiso to oyo (Basics and Applications of Wetting)’ (published on by Realize Inc.). In the case of the cellulose acetate film of the present invention, it is preferable to employ the contact angle method.

Specifically, two types of solutions whose surface energy is known are dropped on the cellulose acetate film, among angles formed between the tangent to a droplet and the film surface at the intersection of the surface of the droplet and the film surface, the angle including the droplet is defined as the contact angle, and the surface energy of the film can be calculated.

In the present invention, in order to improve the adhesion between the cellulose acetate film and a layer (layer, an alignment film, or an optically anisotropic layer) provided thereon, an adhesive layer may be provided (ref. JP-A-7-333433). The thickness of the adhesive layer is preferably 0.1 to 2 μm, and more preferably 0.2 μm to 1 μm.

The application of the cellulose acylate produced in the present invention is now explained briefly. The optical film of the present invention is particularly useful as a polarizing plate protective film. In the case where it is used as a polarizing plate protective film, the method for producing a polarizing plate is not particularly limited, and the plate can be produced by a general method.

There is a method in which the cellulose acylate film obtained is subjected to an alkali treatment, and it is bonded to both sides of a polarizer, which has been produced by dipping a polyvinyl alcohol film in an iodine solution and drawing, using an aqueous solution of a completely saponified polyvinyl alcohol. Instead of the alkali treatment, it may be subjected to an adhesion promotion treatment (ref. JP-A-6-94915, JP-A-6-118232).

Examples of the adhesive used for bonding the protective film treated surface to the polarizer include a polyvinyl alcohol system adhesive such as polyvinyl alcohol or polyvinyl butyral and a vinyl system latex such as butyl acrylate.

The polarizing plate is formed from the polarizer and the protective films protecting the two sides thereof or, furthermore, from a protection film on one side of the polarizing plate and a separator film on the other side. The protection film and the separator film are used in order to protect the polarizing plate while shipping the polarizing plate, inspecting the product, etc. In this case, the protection film is bonded in order to protect the surface of the polarizing plate, and is used on the side opposite to the side of the polarizing plate which is bonded to the liquid crystal plate. The separator film is used in order to cover the adhesive layer which is bonded to the liquid crystal plate, and is used on the side of the polarizing plate which is bonded to the liquid crystal plate. In a liquid crystal display device a substrate containing a liquid crystal is usually disposed between two polarizing plates, but the polarizing plate protective film to which the optical film of the present invention is applied can give excellent display properties in whichever position it is disposed. Since the polarizing plate protective film on the outermost surface on the display side of the liquid crystal display device, in particular, is provided with a transparent hardcoat layer, an antiglare layer, an antireflection layer, etc., the above-mentioned polarizing plate protective film is particularly preferably used in this portion.

The cellulose acylate film of the present invention can be used in various applications, and it is particularly effective as an optical compensation sheet of a liquid crystal display device. In the present invention ‘optical compensation sheet’ and ‘optical compensation film’ have the same meaning.

The cellulose acylate film of the present invention can be used in a liquid crystal cell of various display modes. Various display modes have been proposed, such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned), and HAN (Hybrid Aligned Nematic). Display modes in which the above-mentioned display modes are divided and aligned (multi-domain) have also been proposed. The cellulose acylate film is effective in a liquid crystal display device of any display mode. Furthermore, it is effective in any of the transparent, reflective, and semi-transmissive liquid crystal display devices. The cellulose acylate film of the present invention may be used as a support of an optical compensation sheet of a TN type liquid crystal display device having a TN mode liquid crystal cell. The cellulose acylate film of the present invention may be used as a support of an optical compensation sheet of an STN type liquid crystal display device having an STN mode liquid crystal cell. In general, in the STN type liquid crystal display device, rod-shaped liquid crystal molecules in the liquid crystal cell are twisted in the range of 90 to 360 degrees, and the product (Δn×d) of the refractive index anisotropy (Δn) of the rod-shaped liquid crystal molecules and the cell gap (d) is in the range of 300 to 1,500 nm. The optical compensation sheet used in an STN type liquid crystal display device is described in JP-A-2000-105316. The cellulose acylate film of the present invention is particularly advantageously used as a support of an optical compensation sheet of a VA type liquid crystal display device having a VA mode liquid crystal cell. The cellulose acylate film of the present invention is also advantageously used as a support of an optical compensation sheet of an OCB type liquid crystal display device having an OCB mode liquid crystal cell or a HAN type liquid crystal display device having a HAN mode liquid crystal cell.

The cellulose acylate film of the present invention is also advantageously used as an optical compensation sheet of TN type, STN type, HAN type, and GH (Guest-Host) type reflective liquid crystal display devices. These display modes have been well known for a long time. A TN type reflective liquid crystal display device is described in JP-A-10-123478, WO9848320, and Japanese Patent No. 3022477.

An optical compensation sheet used in a reflective liquid crystal display device is described in International Patent Application No. WO00/65384.

The cellulose acylate film of the present invention is also advantageously used as a support of an optical compensation sheet of an ASM (Axially Symmetric Aligned Microcell) type liquid crystal display device having an ASM mode liquid crystal cell. The ASM mode liquid crystal cell is characterized in that the thickness of the cell is maintained by a resin spacer whose position can be adjusted. Other properties are the same as those of the TN mode liquid crystal cell. An ASM mode liquid crystal cell and an ASM type liquid crystal display device are described in Kume et al., SID 98 Digest 1089 (1998).

Specific applications of the above-mentioned cellulose acylate films are described in detail in ‘Hatsumei Kyokai Koukai Giho (Journal of Technical Disclosure)’ (Technical Disclosure No. 2001-1745, published Mar. 15, 2001, Japan Institute of Invention and Innovation), pp. 45 to 59.

The alignment film, the optically anisotropic layer, and the polarizing film constituting the optical compensation film and the polarizing plate of the present invention are explained below.

(Alignment Film)

The alignment film has the function of defining the alignment direction of discotic liquid crystal molecules in the optically anisotropic layer.

The alignment film can be provided by means such as rubbing of an organic compound (preferably a polymer), oblique vapor deposition of an inorganic compound, formation of a layer having microgrooves, or accumulation of an organic compound (e.g., ω-tricosanoic acid, dioctadecylmethylammonium chloride, methyl stearate) by a Langmuir-Blodgett film method (LB film). Furthermore, an alignment film in which an alignment function is generated by the application of an electric field, application of a magnetic field, or irradiation with light, is also known.

The alignment film is preferably formed by rubbing of a polymer. A preferred polymer is polyvinyl alcohol. A modified polyvinyl alcohol to which a hydrophobic group is bonded is particularly preferable. Since the hydrophobic group has affinity for the discotic liquid crystal molecules of the optically anisotropic layer, by introducing the hydrophobic group into the polyvinyl alcohol, the discotic liquid crystal molecules can be aligned uniformly. The hydrophobic group is bonded to the terminus of the main chain of the polyvinyl alcohol or to a side chain thereof.

The hydrophobic group is preferably an aliphatic group having 6 or more carbon atoms (preferably an alkyl group or an alkenyl group) or an aromatic group.

When the hydrophobic group is bonded to the terminus of the main chain of the polyvinyl alcohol, it is preferable to introduce a coupling group between the hydrophobic group and the terminus of the main chain. Examples of the coupling group include —S—, —C(CN)R¹—, —NR²—, —CS—, and combinations thereof. The above-mentioned R¹ and R² each denote a hydrogen atom or an alkyl group having 1 to 6 carbon atoms (preferably, an alkyl group having 1 to 6 carbon atoms).

When introducing the hydrophobic group into the side chain of the polyvinyl alcohol, a portion of acetyl groups (—CO—CH3) of vinyl acetate units of the polyvinyl alcohol may be replaced with an acyl group (—CO—R³) having 7 or more carbon atoms. R³ denotes an aliphatic or aromatic group having 6 or more carbon atoms.

Commercial modified polyvinyl alcohols (e.g., MP103, MP203, R1130, manufactured by Kuraray Co., Ltd.) may be used.

The degree of saponification of the (modified) polyvinyl alcohol used in the alignment film is preferably 80% or higher. The degree of polymerization of the (modified) polyvinyl alcohol is preferably 200 or higher.

The rubbing treatment is carried out by rubbing the surface of the alignment film by means of paper or cloth in a fixed direction several times. It is preferable to use a cloth in which fibers having uniform length and thickness are uniformly implanted.

Furthermore, even if the alignment film is removed after the discotic liquid crystal molecules of the optically anisotropic layer have been aligned using the alignment film, the aligned state of the discotic liquid crystal molecules can be maintained. That is, although the alignment film is essential in the production of an elliptically polarizing plate in order to align the discotic liquid crystal molecules, it is not essential in the optical compensation sheet thus produced.

When the alignment film is provided between a transparent support and the optically anisotropic layer, an undercoat layer (adhesive layer) may be further provided between the transparent support and the alignment film.

(Optically Anisotropic Layer)

The optically anisotropic layer can be formed from a liquid crystal molecule such as a discotic liquid crystal molecule or a rod-shaped liquid crystal molecule. In the optical compensation sheet of the present invention, the liquid crystal molecules preferably have an angle that varies in the depth direction of the optically anisotropic layer (hybrid-aligned), the angle being formed between the transparent support and the disc surface in the case of the discotic liquid crystal molecules, and the major axis direction in the case of the rod-shaped liquid crystal molecules. The optically anisotropic layer is preferably formed by aligning liquid crystal molecules by the above-mentioned alignment film and fixing the liquid crystal molecules in the aligned state. The liquid crystal molecules are fixed preferably by a polymerization reaction.

The discotic liquid crystal molecules are described in various publications (C. Destrade et al., Mol. Crysr. Liq. Cryst., Vol. 71, page 111 (1981); Kikan Kagaku Sosetu (Quarterly Chemistry Review), No. 22, Ekisho no Kagaku (Chemistry of Liquid Crystals), Chapter V, Chapter X, 2nd Section, Ed. by The Chemical Society of Japan, (1994); B. Kohne et al., Angew. Chem. Soc. Chem. Comm., page 1794 (1985); J. Zhang et al., J. Am. Chem. Soc., Vol. 116, page 2655 (1994)). The polymerization of discotic liquid crystal molecules is described in JP-A-8-27284.

Discotic liquid crystal molecules described in JP-A-8-50286 are preferably used.

As the rod-shaped liquid crystal molecule, an azomethine, an azoxy, a cyanobiphenyl, a cyanophenyl ester, a benzoate ester, a cyclohexanecarboxylate phenyl ester, a cyanophenyl cyclohexane, a cyano-substituted phenylpyrimidine, an alkoxy-substituted phenylpyrimidine, a phenyldioxane, a tolane, or an alkenylcyclohexylbenzonitrile is preferably used. The rod-shaped liquid crystal molecules include metal complexes. The rod-shaped liquid crystal molecules are described in kikan Kagaku Sosetu (Quarterly Chemistry Review, No. 22, Ekisho no Kagaku (Chemistry of Liquid Crystals), Chapter IV, Chapter VII, and Chapter XI, Ed. by The Chemical Society of Japan, (1994) and Ekisho Debaisu Handobukku (Liquid Crystal Device Handbook), Chapter III Ed. by Japan Society for the Promotion of Science, 142nd Committee. Rod-shaped liquid crystal molecules described in JP-A-2001-166145 are preferably used.

The optically anisotropic layer can be formed by applying a coating solution containing discotic liquid crystal molecules and, as necessary, a polymerization initiator or any component on the top of the alignment film.

The thickness of the optically anisotropic layer is preferably 0.5 to 100 μm, and more preferably 0.5 to 30 μm.

The liquid crystal molecules thus aligned are fixed while maintaining the aligned state. Fixation is preferably carried out by a polymerization reaction. The polymerization reaction includes a thermal polymerization reaction employing a thermal polymerization initiator and a photopolymerization reaction employing a photopolymerization initiator. The photopolymerization reaction is preferable.

Examples of the photopolymerization initiator include an α-carbonyl compound (U.S. Pat. Nos. 2,367,661 and 2,367,670), an acyloin ether (U.S. Pat. No. 2,448,828), an α-hydrocarbon-substituted aromatic acyloin compound (U.S. Pat. No. 2,722,512), a polynuclear quinone compound (U.S. Pat. Nos. 3,046,127 and 2,951,758), a combination of a triarylimidazole dimer and a p-aminophenyl ketone (U.S. Pat. No. 3,549,367), acridine and a phenazine compound (JP-A-60-105667, U.S. Pat. No. 4,239,850), and an oxadiazole compound (U.S. Pat. No. 4,212,970).

The amount of photopolymerization initiator used is preferably 0.01 to 20 wt % of the solids content of the coating solution, and more preferably 0.5 to 5 wt %.

Light irradiation for polymerizing the liquid crystal molecules preferably employs UV rays.

The irradiation energy is preferably 20 to 5000 mJ/cm², and more preferably 100 to 800 mJ/cm². Furthermore, in order to promote the photopolymerization reaction, the light irradiation may be carried out with heating.

A protective layer may be provided on the top of the optically anisotropic layer.

(Polarizing Film)

With regard to the polarizing film, there are an iodine based polarizing film, a dye based polarizing film employing a dichromatic dye, and a polyene based polarizing film. The iodine system polarizing film and the dye system polarizing film are generally produced using a polyvinyl alcohol film.

It is preferably arranged so that the angle formed between the phase retardation axis of the polymer film and the transmission axis of the polarizing film is 3° or smaller, more preferably 2° or smaller, and most preferably 1° or smaller.

The polarizing plate of the present invention is preferably used as a functionalized polarizing plate in combination with an LCD viewing angle enlarging film, a λ/4 plate for a reflective type LCD, an antireflection film for improving the recognition of a display, a brightness improving film, or an optical film having a functional layer such as a hardcoat layer, a forward scattering layer, or an antiglare layer.

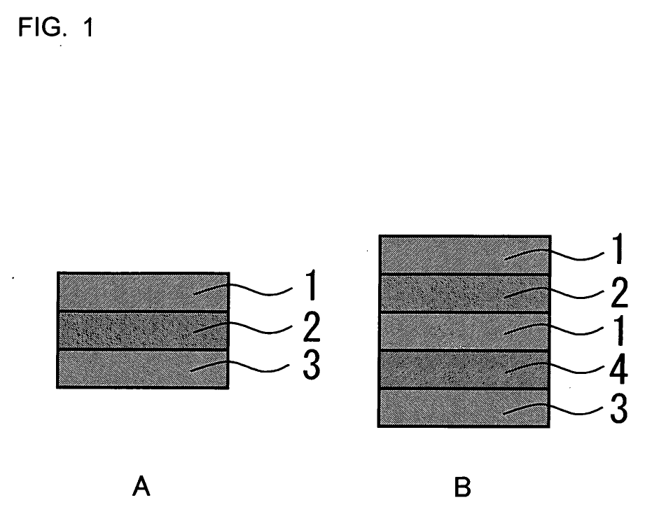

FIG. 1 shows a constitutional example in which the polarizing plate of the present invention and the above-mentioned functional optical film are combined. The functional optical film 3 is used as a protective film on one side of the polarizing plate (polarizer), and this functional film 3 and the polarizer 2 may be bonded using an adhesive (A). Alternatively, the functional optical film 3 may be bonded via an adhesive layer 4 to a polarizing plate formed by providing a protective film 1 on either side of a polarizer (B). In the former case, any transparent protective film can be used as a protective film on the other side. It is preferable to set the peel-off strength between each of the layers such as the functional layer and the protective film so as to be at least 4.0 N/25 mm as described in JP-A-2000-311238. The functional optical film 3 can be disposed on a liquid crystal module side according to an intended function, but it is preferable to dispose it on the side opposite to the liquid crystal module, that is, on a display side or on a backlight side.

The measurement methods and the evaluation test methods employed in the present invention are explained below.

(1 Solubility Test)

The solubility of the functional additives was measured as follows.

1. Solutions were prepared by adjusting each concentration in a 50 cc screw cap bottle.

2. Allowed to stand at room temperature for 4 days. Here, the results of the solubility changed between 1 day and 4 days in some cases, and evaluation of the solubility was carried out after 4 days as a time when equilibrium was reached.

3. Samples were prepared in the same manner at other temperatures (20° C., 35° C.), and the solubility after allowing to stand for 4 days was visually inspected.

(2 Measurement of Micro Heat of Solution)

The heat of solution (dissolution enthalpy ΔH) of functional additives was measured as follows, using a multi-purpose calorimeter (MPC-110) manufactured by Tokyo Rikou as a micro heat of solution measuring instrument.

1. Solvent liquids and concentrated solutions were prepared beforehand in 1 L bottles.

2. Preparation of ampoule tubes

(1) Additives (powdered solid) were ground by a mortar and the granules were made uniform.

(2) A required amount (252 mg) of the additive to be measured was weighed into an ampoule tube for measurement of the micro heat of solution.

(3) The neck of the ampoule tube was heated sufficiently by a gas burner so as to seal the ampoule tube.

3. 50 g of the prepared solvent liquid or the concentrated solution was weighed into a measuring vessel. This amount was selected as an amount sufficient to immerse the ampoule tube in the solvent liquid when set in the measuring instrument.

4. The ampoule tube was set in the measuring instrument, which was equipped with an ampoule sealing mechanism, the measuring vessel was hermetically sealed with the ampoule sealing mechanism after confirming that the ampoule tube was immersed in the solvent liquid, it was placed in a constant temperature bath (26.0° C.), and stirring was started.

5. After confirming that the measuring instrument placed in the constant temperature bath had reached equilibrium temperature (about 8 to 12 hours) the ampoule tube was broken so as to mix the additive with the solvent liquid or the concentrated solution.

6. The total amount of heat generated was recorded.

7. The Joule's heat generated was measured by applying a known voltage to the measurement system for an appropriate time, and the recorded chart area for each measurement cell was calibrated using a known amount of heat.

8. The heat of solution of the sample was calculated from the Joule's heat and the measured sample area.

(3 Gas Chromatography (GC))

Changes in the solvent composition of a dope during drying were examined as follows.

1. A dope was cast on a glass plate, the sample was scraped off or peeled off after a required drying time, and it was dissolved in 30 g of 1,3-dioxolane in a screw cap bottle prepared beforehand. After shaking for 4 to 12 hours so as to adequately dissolve the sample, it was stored in a refrigerator for about 10 to 15 hours until measurement so that the solvent did not evaporate.

2. The components of the dioxolane solution were analyzed by gas chromatography (a standard calibration curve between the peak area and the concentration of each solvent component was made beforehand). Details of the GC measurement conditions were as follows.

| | | |
|---|---|---|
| Column: | GASUKUROPuck54 | 3.1 m × 3.2 mmφ |
| Flow rate: | He | 50 ml |
| Gas pressure: | air, hydrogen | 0.5 kgf/cm² |

Temperature increase conditions: Initial 160° C. Initial time 0 min Rate of temperature increase 2° C./min Second stage temperature 200° C. Second stage time 0 min Total time 20 min

(4 Measurement of Haze)

Measured using a haze meter (Model 1001 DP, manufactured by Nippon Denshoku Industries Co., Ltd.)

(5 Method of Measuring the Retardation Value Rth)

The in-plane retardation Re (0) was measured using an ellipsometer (M-150, manufactured by JASCO Corporation). The retardation Re (40) and Re (−40) were further measured using the in-plane phase retardation axis as a tilt axis and tilting by 40° and −40°. The refractive index ny in the direction of the phase advance axis and the refractive index nz in the thickness direction were determined by calculation so as to fit with these measured values Re (0), Re (40), and Re (−40) using the film thickness and the refractive index nx in the direction of the phase retardation axis as parameters, and the retardation value Rth was determined. The wavelength used for measurement was 632.8 nm.

### EXAMPLES

### Example 1

(Preparation of Cellulose Acetate Solution)

A cellulose acetate solution A was prepared by charging a mixing tank with the composition below and dissolving each component by stirring.

<Composition of Cellulose Acetate Solution A>

| | |
|---|---|
| Cellulose acetate (degree of acetylation 60.9%) | 100.0 parts by weight |
| Triphenyl phosphate (plasticizer) | 7.0 parts by weight |
| Biphenyl diphenyl phosphate (plasticizer) | 4.0 parts by weight |
| Methylene chloride (first solvent) | 402.0 parts by weight |
| Methanol (second solvent) | 60.0 parts by weight |

(Preparation of Matting Agent Solution)

A matting agent solution was prepared by charging a dispersing machine with the composition below and dissolving each component by stirring.

<Composition of Matting Agent Solution>

| | |
|---|---|
| Silica particles having an average particle size of | 2.0 parts by weight |
| 16 nm (AEROSIL R972, manufactured by | |
| Nippon Aerosil Co., Ltd.) | |
| Methylene chloride (first solvent) | 76.3 parts by weight |
| Methanol (second solvent) | 11.4 parts by weight |
| Cellulose acetate solution A | 10.3 parts by weight |

(Preparation of Retardation Increasing Agent Solution)

A retardation increasing agent solution was prepared by charging a mixing tank with the composition below and dissolving each component by stirring while heating.

<Composition of Retardation Increasing Agent Solution>

| | | |
|---|---|---|
| Retardation increasing agent (Example Compound | 19.8 | parts by weight |
| I-(2)) | | |
| UV absorbing agent (A) | 0.07 | parts by weight |
| UV absorbing agent (B) | 0.13 | parts by weight |
| Methylene chloride (first solvent) | 58.4 | parts by weight |
| Methanol (second solvent) | 8.7 | parts by weight |
| Cellulose acetate solution A | 12.8 | parts by weight |

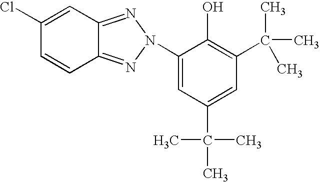

UV absorbing agent A

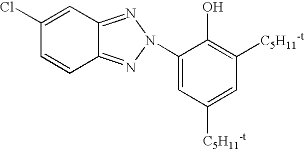

UV absorbing agent B

(Formation of Cellulose Acetate Film)

94.6 parts by weight of the above-mentioned cellulose acetate solution A, 1.3 parts by weight of the matting agent solution, and 4.1 parts by weight of the retardation increasing agent solution were each filtered, then mixed, and cast using a band casting machine. The ratio by weight of the retardation increasing agent relative to the cellulose acetate was 4.6%. The film was peeled off from the band when the amount of residual solvent was 30%, laterally drawn at a draw ratio of 28% using a tenter at 130° C. when the amount of residual solvent was 13 wt %, and held at 140° C. for 30 seconds at the post-drawing width. Subsequently, clips were removed, and the film was dried at 140° C. for 40 minutes to give a cellulose acetate film 101. The amount of residual solvent in the finished cellulose acetate film was 0.2%, and the film thickness was 92 μm.

Cellulose acetate films 102 to 107 were formed in the same manner except that the effective wind speed in the first half of drying prior to peel-off and the retardation increasing agent were changed as in Table 1 below.

TABLE 1

| | Drying wind speed in first | Retardation | |
|---|---|---|---|
| Sample | half of drying prior to peel- | increasing | |
| No. | off (m/min) | agent | Notes |
| 101 | 10 | (I)-2 | Present invention |
| 102 | 20 | (I)-2 | Present invention |
| 103 | 50 | (I)-2 | Present invention |
| 104 | 20 | (I)-11 | Present invention |
| 105 | 50 | (I)-11 | Present invention |

(Measurement of Optical Properties)

The retardation value Rth was measured at a total of 25 points (5 points in the width direction×5 points in the casting direction of the cellulose acetate film formed above), and the average and the standard deviation were calculated.

The results are given in Table 2.

TABLE 2

| | |
|---|---|
| Sample | Rth (nm) |

| No. | Average | Standard deviation | Notes |
|---|---|---|---|
| 101 | 183 | 1.5 | Present invention |
| 102 | 184 | 1.2 | Present invention |
| 103 | 186 | 0.9 | Present invention |
| 104 | 178 | 1.4 | Present invention |
| 105 | 182 | 1.1 | Present invention |

It can be seen from the results above that the films of the present invention have high and uniform in-plane Rth retardation values.

### Example 2

(Saponification Treatment)

The cellulose acetate films 101 to 107 formed in Example 1 were coated with 5.2 ml/m² of a saponifying solution having the composition below, and dried at 60° C. for 10 seconds. The film surface was washed with running water for 10 seconds, and dried by blowing air at 25° C. thereonto. The surface that had been subjected to the saponification treatment lost transparency.

<Composition of Saponifying Solution>

| | |
|---|---|
| Isopropyl alcohol | 818 parts by weight |
| Water | 167 parts by weight |
| Propylene glycol | 187 parts by weight |
| Potassium hydroxide | 68 parts by weight |

(Formation of alignment film)

One surface of the saponified cellulose acetate film (transparent support) was coated with 24 ml/m² of an alignment film coating solution having the composition below using a #14 wirebar coater. The coating was dried with hot air at 60° C. for 60 seconds, and further with hot air at 90° C. for 150 seconds. The coating thus formed was then subjected to rubbing in a direction at 45° relative to the drawing direction (substantially coincident with the phase retardation axis) of the cellulose acetate film (transparent support).

<Composition of Alignment Film Coating Solution>

Modified polyvinyl alcohol having the structure below

| | |
|---|---|
| Modified polyvinyl alcohol having the structure | 20 parts by weight |
| below | |
| Water | 360 parts by weight |
| Methanol | 120 parts by weight |
| Glutaraldehyde (cross-linking agent) | 1.0 parts by weight |

Modified polyvinyl alcohol

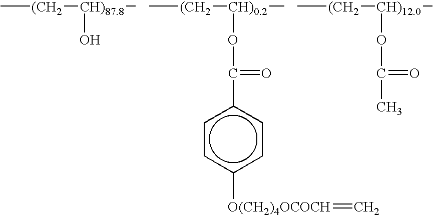

(Formation of Optically Anisotropic Layer)

The top of the alignment film was coated using a #3 wirebar coater with 5.2 ml/m² of a coating solution in which 91 parts by weight of a discotic liquid crystal molecule having the structure below, 9 parts by weight of an ethylene oxide-modified trimethylolpropane triacrylate (V#360, manufactured by Osaka Organic Chemical Industry Ltd.), 1.5 parts by weight of a cellulose acetate butyrate (CAB531-1, manufactured by Eastman Chemical Co.), 3 parts by weight of a photopolymerization initiator (Irgacure 907, manufactured by Ciba-Geigy Ltd.,), and 1 part by weight of a sensitizer (Kayacure DETX, manufactured by Nippon Kayaku Co., Ltd.) were dissolved in 214.2 parts by weight of methyl ethyl ketone. This was affixed to a metal frame and heated in a constant temperature bath at 130° C. for 2 minutes so as to align the discotic liquid crystal molecules. The discotic liquid crystal molecules were then polymerized by irradiating them with UV for 1 minute using a 120 W/cm high pressure mercury lamp at 90° C. This was followed by cooling to room temperature. An optically anisotropic layer was thus formed. 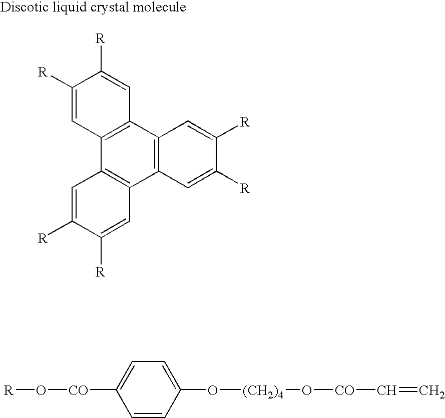
(Formation of Elliptically Polarizing Plate)

A drawn polyvinyl alcohol film was made to adsorb iodine to give a polarizing film.

The transparent support side (nonsaponified side) of the optical compensation sheet formed in Example 2 was then affixed to one side of the polarizing film using a polyvinyl alcohol system adhesive. They were arranged so that the retarded phase axis of the transparent support and the transmission axis of the polarizing film were parallel to each other.

A commercial cellulose triacetate film (Fujitac TD80UF, manufactured by Fuji Photo Film Co., Ltd.) was subjected to saponification in the same manner as above, and affixed to the opposite side (side where no optical compensation sheet was affixed) of the polarizing film using a polyvinyl alcohol system adhesive.

An elliptically polarizing plate was thus formed.

(Formation of bend Alignment Liquid Crystal Cell)

A glass substrate having an ITO electrode was provided with a polyimide film as an alignment film, and the alignment film was subjected to rubbing. Two sheets of the glass substrate thus obtained were arranged facing each other with their rubbing directions parallel at a cell gap of 5.7 μm. A liquid crystal molecule having a Δn of 0.1396 (ZLI1132, manufactured by Merck & Co., Inc.) was poured into the cell gap to give a bend alignment liquid crystal cell.

(Formation of Liquid Crystal Display Device)

Two sheets of the elliptically polarizing plates formed above were affixed so as to sandwich the bend alignment cell formed above. They were arranged so that the optically anisotropic layer of the elliptically polarizing plates faced the cell substrate, and the rubbing direction of the liquid crystal cell and the rubbing direction of the optically anisotropic layers facing it were antparallel to each other.

The liquid crystal display device thus formed was placed on a backlight, a white display voltage of 2 V and a black display voltage of 6.0 V were applied to the liquid crystal cell, and a contrast viewing angle (angular range over which the contrast ratio was 10 or higher) was measured using a measurement instrument (EZ-Contrast 160D, manufactured by ELDIM). A color viewing angle (angular range over which ΔCuv was 0.02 or less) was measured by applying an intermediate tone voltage of 3 V.

The liquid crystal display device employing the cellulose acetate film of the present invention exhibited little display unevenness and gave a good image.

### Example 3

A cellulose acetate solution B was prepared by charging a mixing tank with the composition below and dissolving each component by stirring while heating.

<Composition of Cellulose Acetate Solution B>

| | |
|---|---|
| Cellulose acetate (degree of acetylation 60.9%) | 100.0 parts by weight |
| Triphenyl phosphate (plasticizer) | 7.0 parts by weight |
| Biphenyl diphenyl phosphate (plasticizer) | 4.0 parts by weight |
| Methylene chloride (first solvent) | 402.0 parts by weight |
| Methanol (second solvent) | 60.0 parts by weight |

16 parts by weight of the retardation increasing agent (I)-2, 80 parts by weight of methylene chloride, and 20 parts by weight of methanol were charged into another mixing tank and stirred while heating to give a retardation increasing agent solution D.

474 parts by weight of the cellulose acetate solution B and 11 parts by weight of the retardation increasing agent solution D were mixed and stirred well to give a dope. The amount of retardation increasing agent added was 1.6 parts by weight relative to 100 parts by weight of the cellulose acetate.

The dope thus obtained was cast using a band casting machine at a casting speed of 45 m/min, and after drying until the amount of residual solvent was 30% the film was peeled off from the band. The film was then dried by blowing dry air at 140° C. for 10 minutes to give a cellulose acetate film 201 having an amount of residual solvent of 0.3 wt % and a film thickness of 60 μm.

Cellulose acetate films 202 to 207 were formed in the same manner as for the cellulose acetate film 201 except that the retardation increasing agent and the drying conditions for the first half of drying prior to peel-off were changed as shown in Table 3.

TABLE 3

| | Drying wind | | |
|---|---|---|---|
| | speed in first half of | Retardation | |
| Sample | drying prior to peel-off | increasing | |
| No. | (m/min) | agent | Notes |
| 201 | 10 | (I)-2 | Present invention |
| 202 | 20 | (I)-2 | Present invention |
| 203 | 50 | (I)-2 | Present invention |
| 204 | 20 | (I)-11 | Present invention |
| 205 | 50 | (I)-11 | Present invention |
| 206 | 0 | (I)-2 | Comparative Example |
| 207 | 0 | (I)-11 | Comparative Example |

(Measurement of Optical Properties)

Measured as in Example 1. The results are given in Table 4.

TABLE 4

| Sample | Rth (nm) | | |
|---|---|---|---|
| No. | Average | Standard deviation | Notes |
| 201 | 77 | 1.7 | Present invention |
| 202 | 79 | 1.3 | Present invention |
| 203 | 80 | 0.9 | Present invention |
| 204 | 73 | 1.8 | Present invention |
| 205 | 76 | 1.6 | Present invention |
| 206 | 73 | 3.3 | Comparative Example |
| 207 | 72 | 3.0 | Comparative Example |

It can be seen from the results above that the films of the present invention have high and uniform in-plane Rth retardation values.

### Example 4

Saponification Treatment

The cellulose acetate films 201 to 207 formed in Example 3 were coated with 5.2 ml/m² of a saponifying solution having the composition below, and dried at 60° C. for 10 seconds. The film surface was washed with running water for 10 seconds, and dried by blowing air at 25° C. thereonto.

<Composition of Saponifying Solution>

| | |
|---|---|
| Isopropyl alcohol | 818 parts by weight |
| Water | 167 parts by weight |
| Propylene glycol | 187 parts by weight |
| Potassium hydroxide | 68 parts by weight |

(Formation of Alignment Film)

The saponified cellulose acetate film was coated with 28 ml/m² of a coating solution having the composition below using a #16 wirebar coater. The coating was dried with hot blowing at 60° C. for 60 seconds, and further with hot blowing at 90° C. for 150 seconds.

The coating thus formed was then subjected to rubbing in a direction parallel to the longitudinal direction of the cellulose acetate film.

<Composition of Alignment Film Coating Solution>

| | |
|---|---|
| Modified polyvinyl alcohol having | 10 parts by weight |
| the structure above | |
| Water | 371 parts by weight |
| Methanol | 119 parts by weight |
| Glutaraldehyde (cross-linking agent) | 0.5 parts by weight |

(Formation of Optically Anisotropic Layer)

The top of the alignment film was coated using a #3.6 wirebar coater with a coating solution in which 41.01 g of the discotic liquid crystal molecule above (disc-shaped compound), 4.06 g of an ethylene oxide-modified trimethylolpropane triacrylate (V#360, manufactured by Osaka Organic Chemical Industry Ltd.), 0.90 g of a cellulose acetate butyrate (CAB551-0.2, manufactured by Eastman Chemical Co.), 0.23 g of a cellulose acetate butyrate (CAB531-1, manufactured by Eastman Chemical Co.), 1.35 g of a photopolymerization initiator (Irgacure 907, manufactured by Ciba-Geigy Ltd.), and 0.45 g of a sensitizer (Kayacure DETX, manufactured by Nippon Kayaku Co., Ltd.) were dissolved in 102 g of methyl ethyl ketone. This was heated in a constant temperature zone at 130° C. for 2 minutes so as to align the disc-shaped compound. The disc-shaped compound was then polymerized by irradiating with UV for 1 minute using a 120 W/cm high pressure mercury lamp in an atmosphere at 60° C. Following this, it was cooled to room temperature. An optically anisotropic layer was thus formed, and an optical compensation sheet (D-1) was made.

The retardation value Re of the optically anisotropic layer measured at a wavelength of 546 nm was 43 nm. Furthermore, the angle (tilt angle) between the disc surface and a first transparent support surface was 42° on average.

A drawn polyvinyl alcohol film was made to adsorb iodine to give a polarizer, and the cellulose acetate film of the present invention was affixed to one side of the polarizer on the polarizer side using a polyvinyl alcohol system adhesive. They were arranged so that the transmission axis of the polarizer and the retarded phase axis of the optically anisotropic layer were parallel to each other.

A commercial cellulose triacetate film (Fujitac TD80UF, manufactured by Fuji Photo Film Co., Ltd.) was subjected to saponification in the same manner as above, and affixed to the opposite side of the polarizer using a polyvinyl alcohol system adhesive.

(Formation of Liquid Crystal Display Device)

A pair of polarizing plates provided on a 20 inch liquid crystal display device (LC-20V1, manufactured by Sharp Corporation) employing a TN type liquid crystal cell were peeled off, and one of the polarizing plates prepared above was instead stuck to each of an observer side and a backlight side via an adhesive so that the optical compensation sheet was on the liquid crystal cell side. They were arranged so that the transmission axis of the polarizing plate on the observer side and the transmission axis of the polarizing plate on the backlight side were orthogonal to each other.

It was found that the liquid crystal display device employing the cellulose acetate film of the present invention exhibited little display unevenness and gave a good image.

### Example 5

(Formation of Cellulose Acetate Film)

A cellulose acetate solution A′ was prepared by charging a mixing tank with each of the components below and dissolving each component by stirring while heating.

<Composition of Cellulose Acylate Solution A′>

| | |
|---|---|
| Cellulose acetate (degree of acetylation 60.9%) | 100 parts by weight |
| Triphenyl phosphate (plasticizer) | 7.8 parts by weight |
| Biphenyl diphenyl phosphate (plasticizer) | 3.9 parts by weight |
| Methylene chloride (first solvent) | 300 parts by weight |
| Methanol (second solvent) | 54 parts by weight |
| 1-Butanol | 11 parts by weight |

A retardation increasing agent solution C was prepared by charging another mixing tank with each of the components below and dissolving each component by stirring while heating.

<Composition of Retardation Increasing Agent Solution C>

Retardation Increasing Agent (Example Compound 1-2)

| | |
|---|---|
| Retardation increasing agent (Example | 3 parts by weight |
| Compound I-2) | |
| Methylene chloride | 80 parts by weight |
| Methanol | 20 parts by weight |

15 parts by weight of the retardation increasing agent solution C was added to 474 parts by weight of the cellulose acylate solution A′, and the mixture was stirred well to give a dope. The amount of retardation increasing agent added was 2 parts by weight relative to 100 parts by weight of the cellulose acetate.

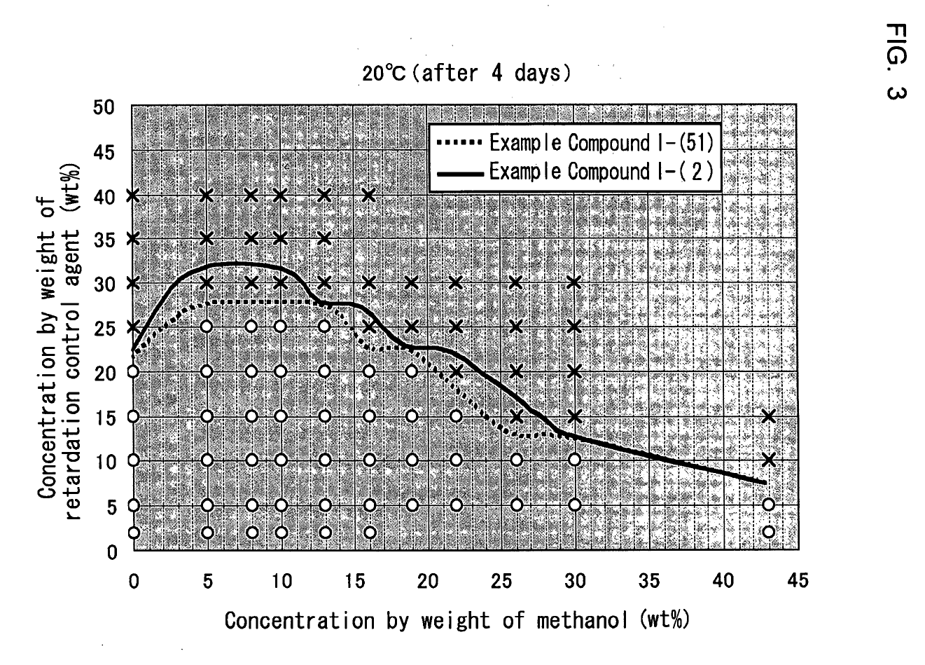

The dope was cast through a casting orifice onto a drum cooled at 0° C. When the solvent content was 70 wt %, the film was peeled off, opposite edges of the film in the width direction were fixed by a pin tenter (a pin tenter illustrated in FIG. 3 of JP-A-4-1009) and dried in a state in which the solvent content was 3 to 5 wt % while maintaining the gap so that the draw ratio in the lateral direction (direction perpendicular to the machine direction) was 3%. The film was subsequently fed between rolls of a heat treatment machine and further dried to give a cellulose acetate film having a thickness of 80 μm, a retardation value Rth of 80 nm, and a retardation value Re of 10 nm.

The effective wind speed during the first half of drying prior to peel-off was 15 m/min.

It was confirmed that the cellulose acetate film produced by the production process of the present invention was also a film having uniform in-plane retardation.

### Example 6

The same effects were obtained even if the cellulose acetate used in Examples 1, 3, and 5 was replaced with ones having a degree of acetylation of 60.7% and 60.5%.

### Examples 7 to 9 and Comparative Example 1

(Solubility of Additive Alone)

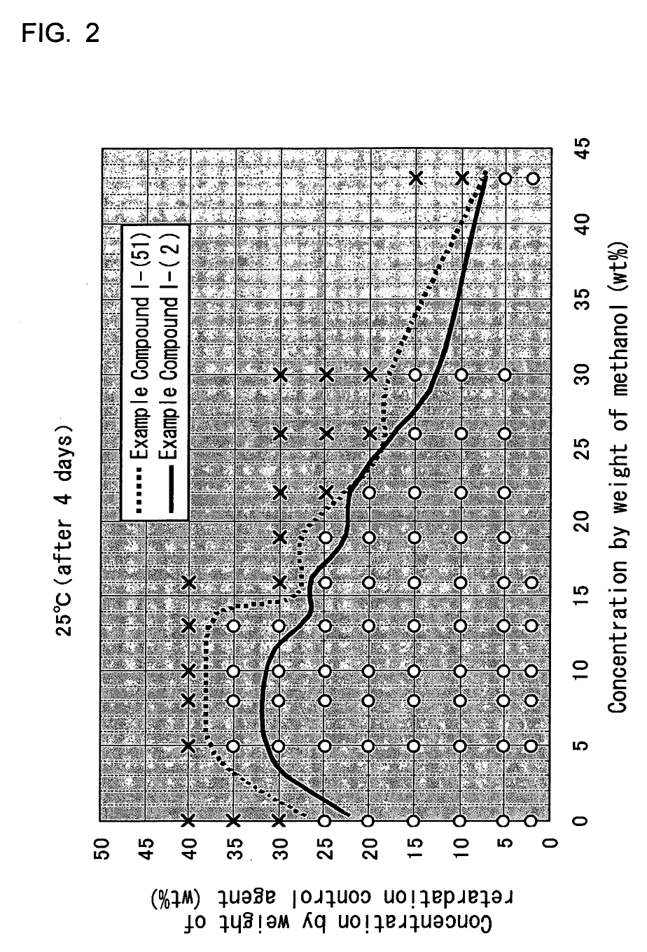

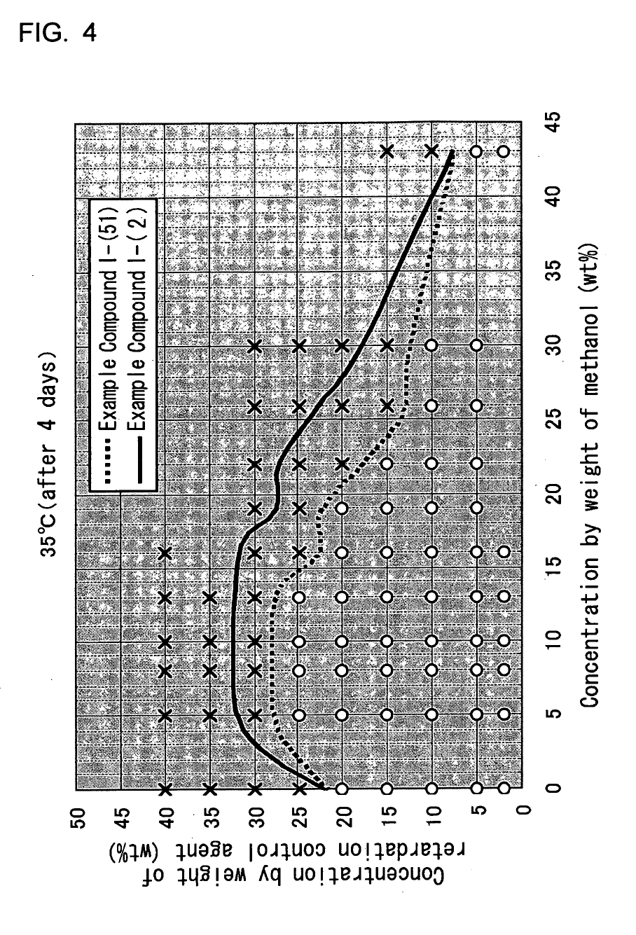

Predetermined amounts of Example Compounds I-(51) and I-(2) were weighed into a mixed solvent of dichloromethane and methanol, and the solubility was measured by changing the mixing ratio of the organic solvents. The solubility at 25° C., 20° C., and 35° C. was as shown in FIG. 2, FIG. 3, and FIG. 4. It was found that when the wt % of methanol in the solvent changed from 10 wt % to 30 wt %, the solubility greatly decreased (wt % at the dissolution limit decreased by more than half).

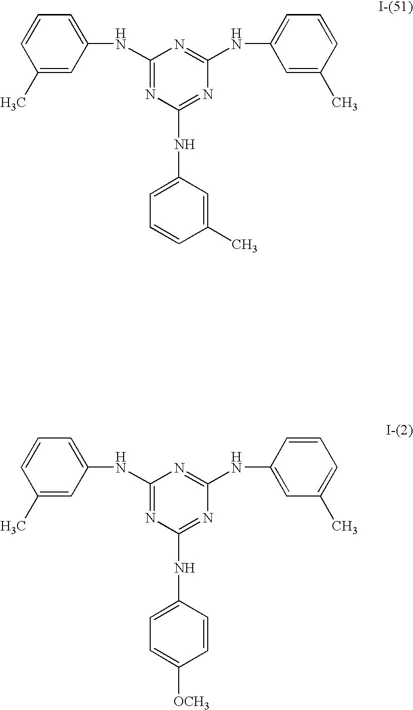

It was found that the solubility of Example Compound I-(2) was excellent at 20° C. and 35° C.

(Change in Solvent Composition During Drying: GC Measurement)

A dope was cast on a glass plate, the dope was sampled at successive drying time intervals into a sample bottle containing dioxolane and dissolved, and changes in the solvent composition during the drying of the dope were examined by GC (described in Table 5).

TABLE 5

| | | | Drying time | | | | | | | |
|---|---|---|---|---|---|---|---|---|---|---|
| Test | | Init. | 1 min | 2 min | 3 min | 4 min | 5 min | 6 min | 7 min | 8 min |
| 1 | CH₂Cl₂ | 87 | — | 80 | — | 74 | 78 | 82 | 81 | 84 |
| | methanol | 13 | | 20 | | 26 | 22 | 18 | 19 | 16 |
| 2 | CH₂Cl₂ | 92 | 92 | 91 | 92 | 92 | 93 | 93 | 93 | 93 |
| | methanol | 8 | 8 | 9 | 8 | 8 | 7 | 7 | 7 | 7 |

It was found that the sample whose composition ratio by weight of dichloromethane to methanol in the initial dope was 87/13 gave a maximum value of the methanol wt % during drying (composition ratio 74/26), and the proportion of methanol was large. As shown in FIG. 2 and FIG. 3, methanol is a solvent having low solubility for the additive (retardation control agent), and in the weight composition of the solvent, the methanol changed by 50% or more (from 13 wt % to 26 wt %) during drying. On the other hand, the sample whose composition ratio by weight of dichloromethane to methanol was 92/8 similarly gave a maximum value of the methanol wt % during drying (composition ratio 91/9), but the proportion of methanol hardly changed from the initial composition ratio.

(Formation of Cellulose Acetate Film)

A cellulose acetate solution was prepared using the composition described in Table 6.

TABLE 6
Composition of cellulose acetate solution

| | | |
|---|---|---|
| Cellulose acetate (degree of acetylation 60.9%) | 100.0 | parts by weight |
| Triphenyl phosphate (plasticizer) | 7.8 | |
| Biphenyl diphenyl phoshate (plasticizer | 3.9 | |
| Methylene chloride (first solvent) | 534.9 | |
| Methanol (second solvent) | 79.9 | |
| Retardation control agent | 5.0 | |
| Fine grain silica (20 nm) | 0.05 | |

The retardation control agents added in the present invention were the same compounds as the Example Compounds I-(51) and I-(2) above.

The dope thus obtained was cast on a film formation band and dried at 80° C. for 7 minutes. The amount of residual solvent after drying was 35 wt % regardless of the type of retardation control agent. The cellulose acetate film was peeled off from the band, dried at 100° C. for 10 minutes and dried at 140° C. for 20 minutes to give a cellulose acetate film. The effective wind speed of drying air was 5 m/sec through out the drying process until peeling off.

The solubility in the mixed solvent of the additive alone shown in FIG. 2 to FIG. 4 and the weeping results of the film obtained above are given in Table 7.

TABLE 7

| | | Solvent | | | | |
|---|---|---|---|---|---|---|
| | | composition | | | | |
| | Retardation | (CH₂Cl₂/CH₃OH) | | | | |
| Temp. | control | 87/13 | 74/26 | Difference | Ratio | |
| (° C.) | agent | S0 | S1 | S0 − S1 | S1/S0 | Weeping |
| 25 | I-(51) | 37.5 | 17.5 | 20 | 0.467 | Bad |
| | I-(2) | 27.5 | 17.5 | 10 | 0.636 | Good |
| 20 | I-(51) | 27.5 | 12.5 | 15 | 0.455 | Bad |
| | I-(2) | 27.5 | 17.5 | 10 | 0.636 | Good |
| 35 | I-(51) | 27.5 | 12.5 | 15 | 0.455 | Bad |
| | I-(2) | 32.5 | 22.5 | 10 | 0.692 | Good |

Bad: Weeping,
Good: No weeping

The solubility (solids weight concentration at the dissolution limit was calculated as (C1+C2)/2 when the concentration limit at which it could be dissolved was C1 and the concentration limit at which it could not be dissolved was C2) of the retardation control agent in a mixed solvent having an initial methylene chloride/methanol composition ratio of 87/13 was defined as S0, and the solubility of the retardation control agent when the solvent composition changed, during drying, to 74/26 where the methanol wt % was the maximum was defined as S1. The temperature at which the solubility was measured is denoted by the figure in brackets.

When the initial solvent composition ratio was 87/13, for the Example Compound I-(51), the difference in solubility denoted by S0−S1 was 15 wt % or larger at any of the temperatures 25° C., 20° C., and 35° C., and the ratio S1/S0 of the solubility was less than 0.5; in comparison with the Example Compound I-(2), both the difference in solubility S0−S1 and the solubility ratio S1/S0 changed to a greater extent, and the Example Compound I-(51) could not exist stably in the dope having an initial composition ratio of 87/13 during drying and there was weeping on the film surface.

That is, it has been found that since the solvent composition changed during drying, the solubility (represented by S0−S1 or S1/S0, etc.) of the additive (retardation control agent) in the dope decreased, the additive could not exist stably in the system, and there was weeping during the film formation process.

In order to prevent the solubility of the retardation control agent from changing during drying, the initial solvent composition was set at dichloromethane/methanol=92/8.

A cellulose acetate solution (dope) was prepared using the composition described in Table 8.

TABLE 8
Composition of cellulose acetate solution

| | | |
|---|---|---|
| Cellulose acetate (degree of acetylation 60.9%) | 100.0 | parts by weight |
| Triphenyl phosphate (plasticizer) | 7.8 | |
| Biphenyl diphenyl phosphate (plasticizer) | 3.9 | |
| Methylene chloride (first solvent) | 565.6 | |
| Methanol (second solvent) | 49.2 | |
| Retardation control agent | 5.0 | |
| Fine grain silica (20 nm) | 0.05 | |

As the retardation control agent, the Example Compounds I-(51) and I-(2) above were used in the preparation above.

The dope thus obtained was cast on a film formation band and dried at 80° C. for 7 minutes. The amount of residual solvent after drying was 35 wt % regardless of the type of retardation control agent. The cellulose acetate film was peeled off from the band, and dried at 100° C. for 10 minutes and dried at 140° C. for 20 minutes to give a cellulose acetate film. The effective wind speed of drying air was 5 m/sec through out the drying process until peeling off.

The solubility in the mixed solvent of the retardation control agents shown in FIG. 2 to FIG. 4 and the weeping results of the films obtained above are given in Table 9.

TABLE 9

| | | Solvent | | | | |
|---|---|---|---|---|---|---|
| | | composition | | | | |
| | Retardation | (CH₂Cl₂/CH₃OH) | | | | |
| Temp. | control | 92/8 | 91/9 | Difference | Ratio | |
| (° C.) | agent | S0 | S1 | S0 − S1 | S1/S0 | Weeping |
| 25 | I-(51) | 37.5 | 37.5 | 0 | 1.000 | Good |
| | I-(2) | 32.5 | 32.5 | 0 | 1.000 | Good |
| 20 | I-(51) | 27.5 | 27.5 | 0 | 1.000 | Good |
| | I-(2) | 32.5 | 32.5 | 0 | 1.000 | Good |
| 35 | I-(51) | 27.5 | 27.5 | 0 | 1.000 | Good |
| | I-(2) | 32.5 | 32.5 | 0 | 1.000 | Good |

Bad: Weeping,
Good: No weeping

The solvent composition of the dope having an initial solvent composition ratio of 92/8 hardly changed during drying as shown in Table 5 and Table 9, the solubility difference (S0−S1) and the solubility ratio (S1/S0) were substantially the same for either of the compounds denoted by Example Compounds I-(51) and I-(2), and the retardation control agent was able to exist stably in the system during the dope drying process and did not weep, thus giving a film having a good surface conditions. Examples and Comparative Example are summarized in Table 10.

TABLE 10

| | | | | Solvent | |
|---|---|---|---|---|---|
| | | | | composition | |
| | | | Solvent | when the | |
| | | Retar- | composition | methanol | |
| | | dation | (dichloro- | proportion was | |
| | | control | methane/ | the highest | |
| | Dope | agent | methanol) | during drying | Weeping |
| Example 7 | Table 6 | I-(2) | 87/13 | 74/26 | Good |
| Comp. | Table 6 | I-(51) | 87/13 | 74/26 | Fair |
| Example 1 | | | | | |
| Example 8 | Table 8 | I-(51) | 92/8 | 91/9 | Good |
| Example 9 | Table 8 | I-(2) | 92/8 | 91/9 | Good |

Bad: Weeping,
Fair: Hardly weeping,
Good: No weeping.

All of the films of the present invention gave a good retardation of 10 nm or less. These films were further MD- and TD-drawn by 5% to 30% at 100° C. to 130° C. either on-line during the drying step of the film formation process or subsequently off-line. A retardation of 20 nm to 160 nm that was proportional to these draw ratios could be exhibited. The haze was measured, and it was 0.5% or less for all of the cellulose acylate films of the present invention. When the cellulose acetate films thus obtained were used in the liquid crystal display device described in Example 1 of JP-A-10-48420, an alignment film coated with polyvinyl alcohol and an optically anisotropic layer containing discotic liquid crystal molecules described in Example 1 of JP-A-9-26572, and an OCB type liquid crystal display device illustrated in FIGS. 10 to 15 of JP-A-2000-154261, good performance was obtained.

As hereinbefore described, in the present invention, it has been found that since the solvent composition during drying changes in a methanol-rich direction, the solubility of the retardation control agent decreases and it weeps onto the surface of the film, and the point is to select a solvent composition that can prevent such weeping. It is therefore important to prevent as much as possible the change in solvent composition from disadvantaging the solubility of the additive. The weeping has been improved by finding a solvent composition that hardly changes.

### Examples 10 to 15 and Comparative Examples 2 and 3

(Stabilization Energy for Retardation Control Agent: Measurement of Micro Heat of Solution)

Shown in Table 11 are the solvent composition (wt %) and the solids composition (parts by weight) of the mother liquor when measuring the heat of solution, the type of retardation control agent sealed in the ampoule tube (Example Compounds I-(51) or I-(2)), and the results of measurement of the heat of solution.

TABLE 11

| | | Composition of dope (mother liquor for measurement of | | | | | | | | |
|---|---|---|---|---|---|---|---|---|---|---|
| | | heat of solution) | | | | | Heat of solution characteristics | | | |
| | Agent sealed | | | Solids composition | | | | | Saturation | |
| | in ampoule | Solvent composition | | (parts by weight) | | | Heat of | Heat of | heat of | Degree of |
| | tube | (wt %) | | | | Biphenyl | solution | solution | solution solids | stabilization |
| | Retardation | Dichloro- | | Triacetyl | Triphenyl | diphenyl | ΔH0 | ΔHs | concentration | (ΔH0 − ΔHs) |
| | control agent | methane | Methanol | cellulose | phosphate | phosphate | (kcal/mol) | (kcal/mol) | (wt %) | (kcal/mol) |
| 1-87a | I-(51) | 87 | 13 | 100 | 7.8 | 3.9 | 4.85 | 4.35 | 5 | 0.5 |
| 2-87a | I-(2) | 87 | 13 | 100 | 7.8 | 3.9 | 7.5 | 6.1 | 5 to 7 | 1.4 |
| 1-87b | I-(51) | 87 | 13 | 100 | — | — | 4.85 | 4.25 | 5 | 0.6 |
| 2-87b | I-(2) | 87 | 13 | 100 | — | — | 7.5 | 5.5 | 5 to 10 | 2 |
| 1-87c | I-(51) | 87 | 13 | — | 7.8 | 3.9 | 4.85 | 4.85 | 0 | 0 |
| 2-87c | I-(2) | 87 | 13 | — | 7.8 | 3.9 | 7.5 | 6.4 | 1 to 2 | 1.1 |
| 1-100a | I-(51) | 100 | 0 | 100 | 7.8 | 3.9 | 5.27 | 3.79 | 10 | 1.48 |
| 2-100a | I-(2) | 100 | 0 | 100 | 7.8 | 3.9 | 6.64 | 5.29 | 10 | 1.35 |
| 1-74a | I-(51) | 74 | 26 | 100 | 7.8 | 3.9 | 4.56 | 4.56 | 0 | 0 |
| 2-74a | I-(2) | 74 | 26 | 100 | 7.8 | 3.9 | 6.97 | 6.97 | 0 | 0 |
| 1-50a | I-(51) | 50 | 50 | 100 | 7.8 | 3.9 | 4.25 | 4.25 | 0 | 0 |
| 2-50a | I-(2) | 50 | 50 | 100 | 7.8 | 3.9 | 6.16 | 6.16 | 0 | 0 |
| 1-92a | I-(51) | 92 | 8 | 100 | 7.8 | 3.9 | 5.03 | 4.23 | 7 | 0.8 |
| 2-92a | I-(2) | 92 | 8 | 100 | 7.8 | 3.9 | 7.21 | 5.83 | 7 | 1.38 |

Identification symbols of system constituents:
atriacetylcellulose/plasticizer (triphenyl phosphate/biphenyl diphenyl phosphate),
btriacetylcellulose,
cplasticizer

In Table 11, the first column shows the identfication number in the measurement of the heat of solution and is expressed as (Retardation control agent)−(wt % of dichloromethane in solvent)(ID of solids constituting the system). The identification symbols of elements constituting the system are as follows: a denotes triacetylcellulose/plasticizer, b denotes triacetylcellulose, and c denotes plasticizer. For example, 2-87a denotes that the retardation control agent is the Example Compound I-(2), the solvent composition (wt %) is dichloromethane/methanol=87/13, and the solids constituting the system are triacetylcellulose and the plasticizer.

The heat of solution ΔH0 denotes the heat of solution (heat absorption) generated when there is no solid in the system (before breaking the ampoule tube) and the retardation control agent is dissolved in a solvent alone. When the heat of solution is measured after increasing the solid concentration in the system, it decreases; when the heat of solution does not change and becomes substantially constant, it is assumed to be saturated, and the heat of solution at this stage is defined as ΔHs. The solids concentration of the system when saturation starts is defined as the saturation heat of solution solids concentration (wt %).

In all cases, when the solids concentration of the system is increased, the heat of solution either remains unchanged from that at a solids concentration of 0 wt % (the saturation heat of solution solids concentration is 0) or decreases and becomes saturated. No change in the heat of solution from that at a solids concentration of 0% suggests that there is no stabilization due to the solids in the system, the heat of solution decreasing and becoming saturated suggests that there is stabilization due to the solids in the system, and the degree of stabilization is unchanged and saturated at a certain solids concentration (saturation heat of solution solid concentration) or higher. This degree of stabilization is expressed as ΔH0−ΔHs, which is the decrease in the heat of solution.

In the case of a where triacetylcellulose and a plasticizer are present in the system and b where only triacetylcellulose is present in the system, both of the retardation control agent Example Compounds I-(51) and I-(2) are stabilized, and the degree of stabilization is larger for Example Compound I-(2). Furthermore, in the case of c where only the plasticizer is present in the system, Example Compound I-(51) is not stabilized, and only Example Compound I-(2) is stabilized.

It is seen from the above that Example Compound I-(51) is stabilized by triacetylcellulose, Example Compound I-(2) is stabilized by both triacetylcellulose and the plasticizer, and as described later Example Compound I-(2) causes less weeping. Furthermore, in the case of a where triacetylcellulose and the plasticizer are present, the change in the solvent composition changes the stabilization energy received by the retardation control agent, and there is no stabilization interaction at a composition (dichloromethane/methanol) of 74/26.

As shown in Table 5, since the solvent composition ratio changes during the drying process, an initial solvent composition ratio (dichloromethane/methanol) of 87/13 becomes a composition ratio of 74/26 during drying, and the system cannot benefit from a stabilization interaction at that composition ratio and becomes unstable. Therefore, compared with an initial solvent composition of 87/13, a ratio of 92/8 in which the solvent composition hardly changes and the stabilization energy hardly changes and remains high is more stable.

(Formation of Cellulose Acetate Film)

Cellulose acetate solutions (dopes) used in Examples and Comparative Examples were prepared using the compositions shown in Table 12 to Table 14.

TABLE 12
Composition of cellulose acetate solution

| | | |
|---|---|---|
| Cellulose acetate (degree of acetylation 60.9%) | 100.0 | parts by weight |
| Triphenyl phosphate (plasticizer) | 7.8 | |
| Biphenyl diphenyl phosphate (plasticizer) 3.9 | | |
| Dichloromethane (first solvent) | 534.9 | |
| Methanol (second solvent) | 79.9 | |
| Retardation control agent | 5.0 | |
| Fine grain silica (20 nm) | 0.05 | |

TABLE 13
Composition of cellulose acetate solution

| | | |
|---|---|---|
| Cellulose acetate (degree of acetylation 60.9%) | 100.0 | parts by weight |
| Triphenyl phosphate (plasticizer) | 7.8 | |
| Biphenyl diphenyl phosphate (plasticizer) | 3.9 | |
| Dichloromethane (first solvent) | 565.6 | |
| Methanol (second solvent) | 49.2 | |
| Retardation control agent | 5.0 | |
| Fine grain silica (20 nm) | 0.05 | |

TABLE 14
Composition of cellulose acetate solution

| | | |
|---|---|---|
| Cellulose acetate (degree of acetylation 60.9%) | 100.0 | parts by weight |
| Triphenyl phosphate (plasticizer) | 7.8 | |
| Biphenyl diphenyl phosphate (plasticizer) | 3.9 | |
| Dichloromethane (first solvent) | 455.0 | |
| Methanol (second solvent) | 159.8 | |
| Retardation control agent | 5.0 | |
| Fine grain silica 20 nm | 0.05 | |

In Tables 12 to 14, the solvent composition (wt %) of dichloromethane to methanol was 87/13, 92/8, or 74/26, and was different in each.

The retardation control agents added in the present invention were Example Compound I-(51) and I-(2) above.

The dopes thus obtained were cast on a film formation band and dried at 80° C. for 7 minutes. The amount of residual solvent after drying was 35 wt % regardless of the type of retardation control agent. The cellulose acetate films were peeled off from the band, dried at 100° C. for 10 minutes, and dried at 140° C. for 20 minutes to give cellulose acetate films. The drying blowing rate on the band is given in Table 15.

The stabilization energy estimated from measurement of the heat of solution of the retardation control agents (Example Compound I-(51), I-(2)) in Table 11 and the weeping results of the films obtained from the dopes are shown in Table 15.

TABLE 15

| | | Retardation | Solvent | Degree of | Drying blow | |
|---|---|---|---|---|---|---|
| | Dope | control agent | composition | stabilization¹⁾ | rate²⁾ | Weeping |
| Example | Table | I-(51) | 87/13 | 0.50 | 5 | Good |
| 10 | 12 | | | | | |
| Example | Table | I-(2) | 87/13 | 1.40 | 5 | Good |
| 11 | 12 | | | | | |
| Example | Table | I-(51) | 92/8 | 0.80 | 5 | Good |
| 12 | 13 | | | | | |
| Example | Table | I-(2) | 92/8 | 1.38 | 5 | Good |
| 13 | 13 | | | | | |
| Example | Table | I-(51) | 92/8 | 0.80 | 7 | Good |
| 14 | 13 | | | | | |
| Example | Table | I-(2) | 92/8 | 1.38 | 7 | Good |
| 15 | 13 | | | | | |
| Comp. | Table | I-(51) | 74/26 | 0 | 5 | Bad |
| Ex. 2 | 14 | | | | | |
| Comp. | Table | I-(2) | 74/26 | 0 | 5 | Bad |
| Ex. 3 | 14 | | | | | |

¹⁾Degree of stabilization is expressed as ΔH0 − ΔHs (kcal/mol)
²⁾Drying blowing rate is expressed as m/min.
Bad: Weeping,
Good: No weeping.

In those having an initial solvent composition of dichloromethane/methanol=87/13 (Examples 10 and 11), the solvent composition changed during drying (Table 5), and the solvent composition ratio was 74/26 when methanol, which is a poor solvent for the additive, was present at its maximum. In order to prevent weeping of the retardation control agent, those provided with stabilization energy throughout the drying process, and those having a high stabilization energy can therefore suppress the weeping.

Furthermore, since the solvent composition of the dope changes during drying, the stabilization energy of the additive (retardation control agent) changes and decreases, thus degrading the weeping properties.

Since the decrease in the stabilization energy accompanying the change in the solvent composition during drying could be made small by setting the solvent composition at 92/8, both of the retardation control agent Example Compounds I-(51) and I-(2) could exist stably in the system during the dope drying process, and did not weep, thus giving films having a good surface condition (Examples 12 to 15).

On the other hand, a dope having a solvent composition of 74/26 had no stabilization energy, the retardation control agent could not exist stably in the system and there was weeping on the film surface while drying the dope to form a film. A film having a good surface condition could not be obtained (Comparative Examples 2 and 3).

All of the films of the present invention gave a good retardation of 10 nm or less. These films were further MD- and TD-drawn by 5% to 30% at 100° C. to 130° C. either on-line during the drying step of the film formation process or subsequently off-line. A retardation of 20 nm to 160 nm could be exhibited that was proportional to these draw ratios. The haze was measured, and it was 0.5% or less for all of the cellulose acylate films of the present invention. When the cellulose acetate films thus obtained were used in the liquid crystal display device described in Example 1 of JP-A-10-48420, an alignment film coated with polyvinyl alcohol and an optically anisotropic layer containing discotic liquid crystal molecules described in Example 1 of JP-A-9-26572, and an OCB type liquid crystal display device illustrated in FIGS. 10 to 15 of JP-A-2000-154261, good performance was obtained.

As hereinbefore described, in the present invention, the point is that it has been found that the stabilization energy estimated from the heat of solution depends on the solvent composition and the type of additive, and the weeping can be improved by adjustment thereof. Furthermore, it has been found that since the solvent composition changes in a methanol-rich direction during drying, the stabilization energy received by the retardation control agent from the system decreases, and the retardation control agent weeps on the surface of the film. It is therefore important to prevent as much as possible the change in the solvent composition from disadvantaging the stabilization of the additive. The weeping has been improved by finding a solvent composition that hardly changes.

### INDUSTRIAL APPLICABILITY

In accordance with the production process of the present invention, a cellulose acylate film having a high retardation value and excellent optical uniformity within the film can be obtained.

In accordance with the present invention, exudation of a functional additive onto a film surface can be suppressed, and a film having an excellent surface condition can be produced continuously and stably.

Furthermore, an optical compensation sheet, a polarizing plate, and a liquid crystal display device employing a cellulose acylate film having the above-mentioned excellent properties can be provided.

1. A process for producing a cellulose acylate film, the process comprising:
a step of preparing a cellulose acylate solution containing 0.01 to 20 parts by weight of an aromatic compound having at least two aromatic rings relative to 100 parts by weight of a cellulose acylate,
a step of casting the cellulose acylate solution on a band or a drum; and
a step of blowing a gas on the cast cellulose acylate solution at an effective wind speed of at least 10 m/min during a first half of drying prior to peel-off.

2. The process for producing a cellulose acylate film according to claim 1, wherein the degree of acylation of the cellulose acylate is in the range of 59.0% to 61.5%.

3. The process for producing a cellulose acylate film according to claim 1, wherein the aromatic compound is a compound represented by Formulae (I) to (IV) below: 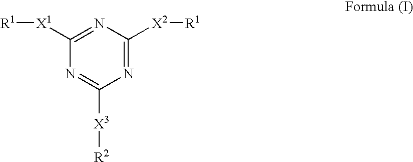
in Formula (I);
R¹ denotes an aromatic ring or a hetero ring having a substituent at the ortho position and/or the meta position, and R² denotes an aromatic ring or a hetero ring which may be substituted.
X¹ denotes a single bond or —NR³—, X² denotes a single bond or —NR⁴—, and X³ denotes a single bond or —NR⁵—; R³, R⁴, and R⁵ independently denote a hydrogen atom, or a substituted or unsubstituted alkyl group, alkenyl group, aryl group, or heterocyclic group; 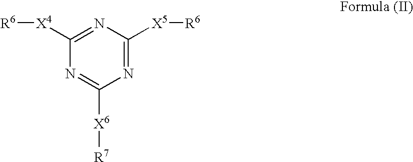
in Formula (II);
R⁶ denotes an aromatic ring or a hetero ring having a substituent at the para position, and R⁷ denotes an aromatic ring or a hetero ring having a substituent, provided that when R⁶ and R⁷ denote aromatic rings, both are not identical;
X⁴ denotes a single bond or —NR¹³—, X⁵ denotes a single bond or —NR¹⁴—, and X⁶ denotes a single bond or —NR¹⁵—; R¹³, R¹⁴, and R¹⁵ independently denote a hydrogen atom, or a substituted or unsubstituted alkyl group, alkenyl group, aryl group, or heterocyclic group; 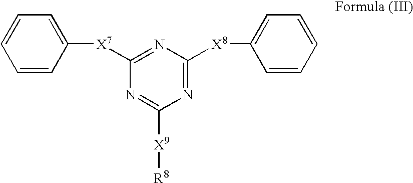
in Formula (III);
R⁸ denotes an aromatic ring or a hetero ring having a substituent at the ortho position and/or the meta position;
X⁷ denotes a single bond or —NR²³—, X⁸ denotes a single bond or —NR²⁴—, and X⁹ denotes a single bond or —NR²⁵—; R²³, R²⁴, and R²⁵ independently denote a hydrogen atom, or a substituted or unsubstituted alkyl group, alkenyl group, aryl group, or heterocyclic group; 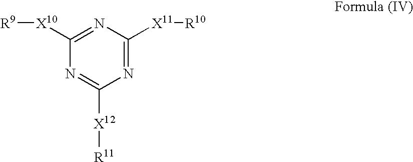
in Formula (IV);
R⁹, R¹⁰, and R¹¹ denote different aromatic rings or hetero rings, which may be substituted;
X¹⁰ denotes a single bond or —NR³³—, X¹ denotes a single bond or —NR³⁴—, and X¹² denotes a single bond or —NR³⁵—; R³³, R³⁴, and R³⁵ independently denote a hydrogen atom, or a substituted or unsubstituted alkyl group, alkenyl group, aryl group, or heterocyclic group.

4. The process for producing a cellulose acylate film according to claim 1, wherein the retardation value Re of the cellulose acylate film calculated from the equation below is in the range of 0 to 100 nm:
Retardation value Re=(nx−ny)×d
(here, nx denotes the refractive index in the direction of the phase retardation axis within the film (direction in which the refractive index is maximum), ny denotes the refractive index in the direction of the phase advance axis within the film (direction in which the refractive index is minimum), and d denotes the thickness (nm) of the film).

5. A process for producing a cellulose acylate film, the process comprising:
a step of preparing a cellulose acylate solution containing a cellulose acylate, a functional additive, a first organic solvent, and a second organic solvent, the solubilities of the functional additive in the first organic solvent and the second organic solvent being different;
a step of casting the cellulose acylate solution on a band or a drum; and
a step of drying the cast cellulose acylate solution so as to remove the organic solvents therefrom; wherein
the solvent composition of mixed organic solvent in the cast cellulose acylate solution changes during the drying step, and
when S1(25) (solids weight concentration of the functional additive) is the solubility of the functional additive at 25° C. in the mixed organic solvent having a solvent composition where the proportion by weight of the first organic solvent, in which the solubility of the functional additive is the lowest, is the highest in the mixed organic solvent, and S0(25) (solids weight concentration of the functional additive) is the solubility of the functional additive at 25° C. in the mixed organic solvent of the solvent composition in the step of preparing the cellulose acylate solution, then for the cellulose acylate solution that is cast,
0≦S0(25)−S1(25)<12.5 or
S1(25)/S0(25)≧0.5.

6. A process for producing a cellulose acylate film, the process comprising:
a step of preparing a cellulose acylate solution containing a cellulose acylate, a functional additive, a first organic solvent, and a second organic solvent, the solubilities of the functional additive in the first organic solvent and the second organic solvent being different;
a step of casting the cellulose acylate solution on a band or a drum; and
a step of drying the cast cellulose acylate solution so as to remove the organic solvents therefrom; wherein
the solvent composition of mixed organic solvent in the cast cellulose acylate solution changes during the drying step, and
when S1(20) (solids weight concentration of the functional additive) is the solubility of the functional additive at 20° C. in the mixed organic solvent having a solvent composition where the proportion by weight of the first organic solvent, in which the solubility of the functional additive is the lowest, is the highest in the mixed organic solvent, and S0(20) (solids weight concentration of the functional additive) is the solubility of the functional additive at 20° C. in the mixed organic solvent of the solvent composition in the step of preparing the cellulose acylate solution, then for the cellulose acylate solution that is cast,
0≦S0(20)−S1(20)<12.5 or
S1(20)/S0(20)≧0.5.

7. A process for producing a cellulose acylate film, the process comprising:
a step of preparing a cellulose acylate solution containing a cellulose acylate, a functional additive, a first organic solvent, and a second organic solvent, the solubilities of the functional additive in the first organic solvent and the second organic solvent being different;
a step of casting the cellulose acylate solution on a band or a drum; and
a step of drying the cast cellulose acylate solution so as to remove the organic solvents therefrom; wherein
the solvent composition of the mixed organic solvent in the cast cellulose acylate solution changes during the drying step, and
when S1(35) (solids weight concentration of the functional additive) is the solubility of the functional additive at 35° C. in the mixed organic solvent having a solvent composition where the proportion by weight of the first organic solvent, in which the solubility of the functional additive is the lowest, is the highest in the mixed organic solvent, and S0(35) (solids weight concentration of the functional additive) is the solubility of the functional additive at 35° C. in the mixed organic solvent of the solvent composition in the step of preparing the cellulose acylate solution, then for the cellulose acylate solution that is cast,
0≦S0(35)−S1(35)<12.5 or
S1(35)/S0(35)≧0.5.

8. A process for producing a cellulose acylate film, the process comprising:
a step of preparing a cellulose acylate solution containing a cellulose acylate (a), an additive (b) selected from the group consisting of a plasticizer, a retardation control agent, a degradation inhibitor, and a UV absorbing agent, and an organic solvent or a mixed organic solvent (c);
a step of casting the cellulose acylate solution on a band or a drum; and
a step of drying the cast cellulose acylate solution so as to remove the organic solvent therefrom; wherein for the cellulose acylate solution that is cast, the heat of solution ΔH0 of the additive (b) in the organic solvent or mixed organic solvent (c) is larger than the heat of solution ΔHs thereof in a solution in which only the cellulose acylate (a) is dissolved, and ΔH0−ΔHs is 0.3 kcal/mol or more.

9. A process for producing a cellulose acylate film, the process comprising:
a step of preparing a cellulose acylate solution containing a cellulose acylate (a), an additive (b′) selected from the group consisting of a retardation control agent, a degradation inhibitor, and a UV absorbing agent, a plasticizer (b1), and an organic solvent or a mixed organic solvent (c);
a step of casting the cellulose acylate solution on a band or a drum; and
a step of drying the cast cellulose acylate solution so as to remove the organic solvent therefrom; wherein
for the cellulose acylate solution that is cast, the heat of solution ΔH0 of the additive (b′) in the organic solvent or mixed organic solvent (c) is larger than the heat of solution ΔHs thereof in a solution in which the plasticizer (b1) alone is dissolved, and ΔH0−ΔHs is 0.3 kcal/mol or more.

10. A process for producing a cellulose acylate film, the process comprising:
a step of preparing a cellulose acylate solution containing a cellulose acylate (a), an additive (b′) selected from the group consisting of a retardation control agent, a degradation inhibitor, and a UV absorbing agent, a plasticizer (b1), and an organic solvent or a mixed organic solvent (c);
a step of casting the cellulose acylate solution on a band or a drum; and
a step of drying the cast cellulose acylate solution so as to remove the organic solvent therefrom; wherein
for the cellulose acylate solution that is cast, the heat of solution ΔH0 of the additive (b′) in the organic solvent or mixed organic solvent (c) is larger than the heat of solution ΔHs thereof in a solution in which the cellulose acylate (a) and the plasticizer (b1) are dissolved, and ΔH0−ΔHs is 0.3 kcal/mol or more.

11. The process for producing a cellulose acylate film according to claim 10, wherein the difference ΔH0−ΔHs of the heats of solution is 0.6 kcal/mol or more.

12. A process for producing a cellulose acylate film, wherein the cellulose acylate solution according to claim 1 is cast as an outermost layer.

13. A cellulose acylate film produced by the process according to claim 1.

14. An optical compensation film employing a cellulose acylate film produced by the process according to claim 1.

15. An optical compensation sheet provided with an optically anisotropic layer formed from a liquid crystal molecule on the cellulose acylate film according to claim 13.

16. An optical compensation film employing a cellulose acylate film produced by the production process according to claim 7 wherein the additive is an aromatic compound having at least two aromatic rings, and the aromatic compound having at least two aromatic rings is contained at 0.01 to 20 parts by weight relative to 100 parts by weight of the cellulose acylate.

17. A polarizing plate comprising a transparent protective film, a polarizing film, a transparent support, and an optically anisotropic layer formed from a liquid crystal molecule laminated in that order, wherein the transparent support is the cellulose acylate film according to claim 13.

18. An image display device employing at least one of the optical compensation film according to claim 15.

19. A liquid crystal display device comprising a liquid crystal cell, and two polarizing plates disposed on either side thereof, at least one of the polarizing plates being the polarizing plate of claim 17.
